(19) United States
(12) Patent Application Publication
(10) Pub. No.: US 2026/0121169 A1
(43) Pub. Date: Apr. 30, 2026

(54) cooling and life-extending device suitable for electric transportation equipment and its auxiliary facilities

(71) Applicant: Leo Sun, Charlotte, NC (US)

(72) Inventors: Yueqin Cui, Luoyang (CN); Long Chen, Wuhan (CN); Minfen Liang, Wuhan (CN); Wenjun Fan, Wuhan (CN)

(21) Appl. No.: 19/433,830

(22) Filed: Dec. 28, 2025

(30) Foreign Application Priority Data
Sep. 27, 2025 (CN) 2025113932657

(51) Int. Cl. H01M 10/6569; B60L 50/64; B60L 58/26; H01M 10/613; H01M 10/625; H01M 10/63; H01M 10/6551; H01M 10/6554; H01M 10/6561

(52) U.S. Cl. CPC H01M 10/6569; H01M 10/613; H01M 10/625; H01M 10/63; H01M 10/6551; H01M 10/6554; H01M 10/6561; B60L 50/64; B60L 58/26; H01M 2220/20

(57) ABSTRACT

Existing electric transportation equipment and its auxiliary facilities mostly rely on heating or insulation devices to cope with low-temperature environments, which is not only energy-intensive but also costly. Based on experimental findings, this invention discloses a cooling and life-extending device suitable for electric transportation equipment and its auxiliary facilities, including but not limited to functional units: battery module 405, cooling system 101, and air duct 102. This device actively maintains the battery module in a low-temperature range to extend battery life and improve economic efficiency throughout its life cycle. It incorporates a comprehensive strategy including multi-stage cooling, intelligent temperature control, and capacity redundancy, enabling the battery to operate stably at low-temperatures. This cooling and life-extending device transforms the scientific discovery of “low-temperature life-extending” into an engineeringable solution, significantly improving battery life and system efficiency while reducing energy consumption and operating costs for heat dissipation, demonstrating significant innovation and industrialization value.

### CROSS REFERENCE TO RELATED APPLICATIONS

This application claims priority to Chinese Patent Application No. 2025113932657, filed on Sep. 27, 2025, in China, the entire contents of which are hereby incorporated by reference.

### TECHNICAL FIELD

This invention relates to the field of battery technology for electric vehicles and electric transportation equipment, and particularly to a cooling and life-extending device capable of actively reducing the temperature of battery modules to extend battery life. This invention is applicable to various electric vehicles and special equipment, including passenger cars, electric trucks, flying cars, electric mining vehicles, electric construction machinery, electric ships, electric port equipment, military equipment, and unmanned vehicles. Furthermore, this invention can also be extended to auxiliary facilities such as battery swapping stations, charging and discharging stations, mobile energy storage devices, rail charging facilities, and maintenance and testing platforms, and is applicable to power infrastructure fields such as energy storage power stations, emergency power supplies, and microgrids.

### BACKGROUND OF THE INVENTION

With the rapid development of battery technology, electric transportation equipment and its auxiliary facilities are being used more and more widely. As the core power source, the performance and lifespan of the battery module directly determine the range, power output, and economy of electric transportation equipment and its auxiliary facilities. However, compared with traditional fuel vehicles, existing electric vehicles generally suffer from a shorter battery life, which not only limits the vehicle's service life but also significantly affects consumers' willingness to purchase and the overall life-cycle economy of the vehicle. Therefore, how to significantly enhance the lifespan of battery modules has become a key technical challenge to promote the widespread application of electric vehicles.

Furthermore, in low-temperature environments, especially in winter, the usable capacity of batteries decreases, leading to a significant reduction in the driving range of electric vehicles. Existing technologies typically employ heating or insulation devices to maintain the battery temperature, preventing damage or performance degradation at low-temperatures. However, these methods are passive measures, consuming significant energy and incurring high costs. Traditional thermal management technologies are primarily safety-oriented, aiming to maintain the battery within the normal temperature range, lacking effective solutions for actively extending battery life at low-temperatures. Therefore, this provides a clear space for technical improvement for the present invention, highlighting its innovative value and industrial application potential in battery life-extending and energy saving.

### SUMMARY OF THE INVENTION

This invention innovatively addresses the bottleneck problems existing in battery usage scenarios. Existing battery heating or insulation devices are mainly based on the principle of heating compensation, which has high energy consumption and limited effectiveness. Therefore, this invention proposes a disruptive concept centered on “actively embracing low-temperatures and extending battery life,” and achieves a technological breakthrough through systematic innovation. It not only significantly extends battery life but also effectively controls system energy consumption, achieving a balance between economy and safety throughout the entire life cycle. While the technical solution of this invention can seem similar to traditional battery thermal management technologies at first glance, they are fundamentally different. Existing battery thermal management technologies only focus on maintaining the battery at normal temperature conditions to prevent overheating or overcooling; their design philosophy is “avoiding high temperatures, avoiding low-temperatures, and maintaining normal temperature.” Under this philosophy, the energy consumption of the heat dissipation system is usually low, and ordinary heat dissipation methods can meet the needs of practical applications.

The inventors of this invention discovered through long-term systematic experiments that various types of batteries can achieve unexpected lifespan extensions under low-temperature conditions, even significantly extending them by three to four times, which is of revolutionary significance. This discovery completely overturns the existing battery thermal management concept: evolving from “avoiding high temperatures, avoiding low-temperatures, and embracing room temperatures” to “embracing low-temperatures and embracing longevity.” The core of this invention lies in effectively utilizing experimental findings to make battery life-extending the primary design goal, breaking through traditional concepts. Based on scientific discoveries and objective laws, this invention achieves a transformation and upgrade based on existing battery thermal management device solutions.

To achieve this goal, the battery temperature must be lowered to a low-temperature operating range, which obviously increases the energy consumption of the heat dissipation system significantly. However, this is something that professionals in the field would not choose and would even try to avoid, because low-temperature environments will cause a loss of battery capacity, and maintaining a low-temperature scenario also requires a more complex heat exchange design than a “normal temperature scenario,” and will consume additional energy during operation, resulting in a triple loss. This solution overcomes these problems through new discoveries and designs: it can not only extend the lifespan, reduce energy consumption and operating costs, but also achieve a higher return on investment from the perspective of the entire life cycle.

This invention designs a comprehensive cooling and life-extending system that can minimize energy consumption while ensuring extended battery life. Through multi-stage cooling, intelligent temperature control, and capacity redundancy strategies, it achieves long-term stable operation of the battery at low-temperatures and obtains unexpected results. Compared with the prior art, this invention not only breaks through the constraints of traditional thermal management concepts, but also proposes a completely new solution in system design concepts, functional implementation, and control strategies, achieving a leapfrog development and simultaneously improving battery life and system efficiency. This design concept, which starts from extending life to enhance economics throughout the entire life cycle, rather than merely preventing overheating, forms the core inventiveness of this invention.

Compared with the prior art, the present invention has significant inventiveness. First, in terms of technical design concept, the present invention takes battery life-extending as the core objective, rather than merely preventing overheating or maintaining normal temperature, and successfully achieves a concept upgrade from traditional “safety temperature management” to “low-temperature life-extending management”. This concept breaks through the basic understanding of existing battery thermal management, enabling the system design to not only focus on safety, but also actively pursue the goal of significantly extending battery life. This is because the inventors discovered through long-term experiments that batteries can significantly slow down the aging rate of electrode materials and electrolytes in low-temperature environments, thereby extending cycle life and overall life cycle economy. This discovery completely overturns traditional understanding and is an unexpected effect that the prior art could not foresee.

Furthermore, lower temperatures also mean higher heat dissipation energy consumption. How to control system energy consumption under low-temperature operating conditions so that the heat dissipation system can still maintain high energy efficiency under the life-extending target is another challenge. To this end, the present invention proposes a comprehensive solution including a multi-stage cooling system, optimized air duct, refrigerant auxiliary circuit, capacity redundancy design, and intelligent temperature control module. By dynamically adjusting the coolant flow rate, fan speed, or the start and stop of the refrigeration system, the system can accurately control the battery temperature under different loads and environmental conditions, while avoiding unnecessary energy consumption at low-temperatures. This system design, which focuses on low-temperature life-extending and takes into account energy efficiency optimization, is a fundamental innovation of existing battery thermal management technology and is also the core technological breakthrough of the present invention.

Furthermore, this invention also solves the problem of extreme working conditions that traditional technologies struggle to address. In high-load, high-temperature, or high-dust mining vehicle environments, ordinary cooling systems are prone to problems such as insufficient heat dissipation, localized overheating, or blockage. However, this invention achieves long-term stable, efficient, and reliable system operation through modular design, redundant functions, thermal connection and insulation strategies, as well as dustproof, anti-blockage, and airflow optimization methods. Simultaneously, the combination of capacity redundancy and intelligent temperature control can compensate for capacity loss caused by a decrease in chemical reaction rate under low-temperature extended lifespan conditions, ensuring the stability of range and power output. This not only reflects technological innovation but also demonstrates the system's adaptability and reliability advantages under complex working conditions.

This invention also proposes several innovative measures in terms of local temperature control, zoned heat dissipation, branch circuits, thermal connection and insulation design, and phase change material cold storage assistance to ensure the internal temperature balance of the battery module and solve the problem of local overcooling or performance degradation that can be caused by low-temperature life-extending. The intelligent temperature control closed-loop system monitors the battery temperature, coolant temperature and environmental parameters in real time, and dynamically adjusts the system operation mode, operation intensity and topology to unify the life-extending target and energy efficiency optimization, achieving low-temperature life-extending and energy-saving control that cannot be simultaneously met by existing technologies.

Through the above technical solutions, this invention not only proposes a brand-new design concept centered on extending battery life, but also achieves the unity of low-temperature battery life-extending and energy efficiency optimization through systematic and multi-dimensional technological innovation, forming an overwhelming advantage that is significantly superior to existing technologies. This innovative solution can significantly extend the battery life throughout its entire life cycle, while taking into account low energy consumption and high reliability, providing unprecedented industrial application value for electric vehicles and electric transportation equipment. Most importantly, this invention can produce unexpected technical effects. When operating in the life-extending low-temperature range, the battery cycle life is significantly extended, and the capacity decay is significantly slowed down, thereby achieving economic benefits that existing technologies cannot achieve. This not only verifies the scientific nature of the low-temperature life-extending concept, but also fully demonstrates the overwhelming advantages of this invention in technological innovation, system integration, and industrial application.

The core idea of this invention is to overturn the traditional temperature control concept of “avoiding low-temperatures” and actively utilize the low-temperature environment as a key condition for optimizing battery life. It combines the characteristics of electric vehicles to design a low-temperature management scheme for battery modules, aiming to improve the lifespan of lithium batteries. This scheme not only extends battery life but also significantly reduces system energy consumption, improving the overall economy and safety of the system. Through the scientific layout of the cooling and life-extending device and precise temperature monitoring strategy, this invention achieves battery life-extending in low-temperature environments in the field of electric vehicles, providing a new technical path and economic model for large-scale intelligent electric vehicles. To achieve the above and other related objectives, this invention provides a cooling and life-extending device suitable for electric transportation equipment and its auxiliary facilities, characterized in that:
The cooling and life-extending device includes several functional units, sub-components and secondary components. The functional units can include, but are not limited to: battery module, cooling system, and air duct.
The sub-components of the cooling system include a coolant pump, a radiator, a cooling plate, and interconnected cooling pipes.
The air duct defines the airflow path, allowing air to flow through the radiator, and the air is finally discharged to the outside after heat exchange.
The cooling and life-extending device can stably control the temperature of the battery module within the life-extending low-temperature range, thereby extending the life of the battery module and significantly enhancing its economic efficiency throughout its entire life cycle.
The life-extending low-temperature range is a low-temperature range below room temperature but above the dew point. When the battery module is used for a long time within this life-extending low-temperature range, it can slow down the aging and degradation of electrode materials and electrolyte, thereby extending its lifespan.
The cooling system contains circulating coolant. A coolant pump drives the coolant to circulate within the cooling system. The cooling plate is in close contact with the battery module that needs cooling, enabling the coolant to efficiently absorb the heat generated by the battery module during operation. The coolant is transported to a radiator via cooling pipes, where the radiator exchanges heat with the air through convection. The cooled coolant then flows back to the cooling plate, achieving a continuous and stable cooling effect. The cooling plate can also be in close contact with other sub-components or secondary components that need cooling to achieve the purpose of cooling.
The battery module undertakes the core functions of energy storage and output, and is the core component of the electric transportation equipment and its auxiliary facilities. It is also the direct cooling target and life-extending carrier of the cooling and life-extending device.
The functional unit refers to the overall module in the cooling and life-extending device used to realize the main function. The sub-component refers to the subdivided structure or independently operable component under the functional unit. The secondary component refers to the specific element or hardware component after the sub-component is further subdivided.

This invention, through a systematic cooling and life-extending device, can not only precisely control the battery module temperature within the optimal life-extending range, thereby significantly extending the battery's lifespan, but also achieve efficient thermal management, reduce energy loss, and improve the economy and reliability of the entire vehicle system. Simultaneously, the device has a reasonable structure, combining the cooling system with the air duct to facilitate rapid and efficient heat transfer and dissipation.

Optionally, the cooling and life-extending device is used to actively promote the temperature reduction of the battery module and maintain it in the life-extending low-temperature range, rather than just to prevent thermal runaway; the functional unit of the cooling and life-extending device can be replaced with other structures, or combined with other structures to achieve the above-mentioned purpose of cooling and life-extending; the functional unit can also select to implement any of the following temperature control strategies according to specific needs: passive heat dissipation, air cooling, convection cooling, active cooling or thermal compensation, or select a combination of multiple strategies to construct a multi-stage coupled temperature control system.

This design actively utilizes multiple heat dissipation methods to achieve temperature control in order to extend battery life.

Optionally, each functional unit, sub-component and secondary component in the cooling and life-extending device is optional, wherein the electrically related parts have a sealed structure to suppress condensation and improve adaptability under low-temperature conditions.

Optionally, when the battery module operates in the life-extending low-temperature range, although its lifespan can be extended, its electrochemical reaction rate is reduced, resulting in a reduction in initial capacity; therefore, the battery module is configured with a capacity redundancy function.

Optionally, the capacity redundancy function is achieved by pre-setting additional redundant capacity for the battery module to compensate for the capacity loss of the battery module when operating in a low-temperature environment; the capacity redundancy function is an optional configuration.

Optionally, the capacity redundancy function can be achieved by adding a battery expansion pack and cooperating with the battery module to achieve excess redundancy; or by designing the total capacity of the battery module according to a preset redundancy ratio to achieve excess redundancy design from the source of the solution.

Optionally, the capacity redundancy function can selectively enable or disable the battery expansion pack according to the external load demand, or automatically adjust the overall operating intensity of the battery module, so that the total capacity of the battery module can flexibly meet the external load demand and can respond in time when the demand suddenly increases.

Optionally, the capacity redundancy function can not only compensate for the capacity loss of the battery module in the low-temperature life-extending range, but also further improve the life of the battery module on the basis of the life-extending caused by low-temperature.

The capacity redundancy function can dynamically compensate for capacity loss in low-temperature environments, improve the reliability and range flexibility of the battery module, and ensure stable power supply under different load conditions.

Optionally, the air duct can also cause air to flow through any functional unit or its sub-components or secondary components and exchange heat with them, thereby enhancing the overall heat dissipation effect of the cooling and life-extending device.

This design optimizes the airflow path, enabling the air duct to guide air to any functional unit or its sub-components or secondary components for heat exchange, thereby enhancing the overall heat dissipation efficiency. This not only improves the balance of heat conduction and dissipation, but also improves the temperature distribution stability of the battery module, further extending battery life and reducing the risk of local overheating.

Optionally, the functional unit of the cooling and life-extending device further includes: a refrigeration system.

Optionally, the sub-components of the refrigeration system include a condenser, a compressor, a throttling device, an evaporator, and interconnected refrigeration pipes.

Optionally, the refrigeration system contains a refrigerant; the refrigerant circulates and undergoes a phase change within the refrigeration system, and exchanges heat with each sub-component of the refrigeration system in sequence.

Optionally, the refrigeration system is activated when the ambient temperature is too high or the heat dissipation efficiency of the cooling system is insufficient to reduce the coolant to the target temperature, so as to further enhance the heat dissipation effect of the cooling and life-extending device and ensure that the battery module is in the life-extending low-temperature range.

Optionally, the compressor compresses the low-pressure gaseous refrigerant into a high-temperature and high-pressure gas, which is then sent to the condenser through the refrigeration pipe to release heat and condense it into a liquid; subsequently, the refrigerant enters the evaporator after being depressurized and cooled by the throttling device, where it absorbs heat and evaporates into a gas, and then returns to the compressor to form a cyclic refrigeration process; wherein, the condenser is coupled with the air duct, and the heat released by the refrigerant in the condenser is transferred through the air duct and finally discharged to the outside; the evaporator is coupled with the radiator (or other components) in the cooling system, and the refrigerant absorbs heat in the evaporator, thereby reducing the temperature of the radiator in the cooling system and achieving auxiliary cooling of the coolant.

Optionally, the throttling device is preferably a thermostatic expansion valve or an electronic expansion valve, or it can be a capillary tube, a float valve, a needle valve, an electronic proportional valve, a two-stage expansion valve or an adjustable orifice capillary tube, etc., which can adjust the refrigerant flow according to the load of the evaporator or the system control requirements, thereby ensuring the stable heat absorption and circulating cooling effect of the evaporator.

By introducing a refrigeration system, the present invention provides an auxiliary refrigeration method on the basis of the traditional cooling system, which can be activated when the ambient temperature is high or the cooling system efficiency is insufficient, so as to achieve precise temperature control of the battery module. This multi-loop coordinated heat dissipation method not only enhances the cooling capacity, but also maintains the stability of the battery module in the life-extending low-temperature range.

Optionally, the functional unit of the cooling and life-extending device further includes: an integrated control module.

Optionally, the integrated control module is also equipped with a decision control algorithm, which can dynamically adjust the coolant flow rate, fan speed or start-up and shutdown of the refrigeration system according to the battery module temperature, coolant temperature and ambient temperature, or the load requirements of the battery module, so that the battery temperature is kept stable in the long-term life-extending low-temperature range; wherein, if the ambient temperature is too low, the coolant flow rate is reduced to avoid the battery being overcooled.

Optionally, the functional unit of the cooling and life-extending device further includes an integrated control module; the integrated control module can ensure that one or more operating characteristics of the battery module do not exceed the preset operating condition threshold during charging and discharging, so as to avoid the rapid increase of the side reaction rate of the battery module under adverse operating conditions.

Optionally, the operating characteristics include one or more of the following: charging current, charging voltage, discharging voltage, discharging current, charging and discharging power, temperature, and other battery operating condition parameters.

Optionally, when the integrated control module detects that one or more operating characteristics are close to or exceed the preset operating condition threshold, a protection mechanism will be triggered. The protection mechanism includes, but is not limited to: reducing the charging current, reducing the discharging current, reducing the charging and discharging power and/or voltage, performing a circuit breaker action, and issuing an alarm signal.

Optionally, the integrated control module can also monitor the internal and external operating parameters of the electric transportation equipment, its auxiliary facilities and the cooling and life-extending device in real time, then analyze the parameters through a decision control algorithm, and adjust the operating strategy and/or operating intensity of the cooling and life-extending device as needed based on the analysis results, so as to enhance the continuous temperature control capability and the precise temperature control capability.

The integrated control module can achieve dynamic and intelligent adjustment, so that the battery can be kept in the optimal life-extending low-temperature range, improve battery life, system stability and overall energy efficiency, and avoid excessive cooling or energy waste.

Optionally, the life-extending low-temperature range can be around 10° C., around 15° C., around 20° C., or other temperature ranges below room temperature.

Optionally, the range of the life-extending low-temperature range and the setting of the preset operating condition threshold can vary depending on the type and model of the battery module, and can be affected by the chemical system, capacity, rated voltage and operating environment conditions of the battery module.

Optionally, the life-extending low-temperature range and/or preset operating condition threshold can be determined through experiments, tests or a combination of those methods; specific determination methods include but are not limited to: determining by accelerated aging test, charge-discharge cycle test or thermal characteristic analysis; selecting based on experience or manufacturer recommendations; predicting by combining battery thermal management model, aging model or chemical kinetic simulation; performing statistical analysis based on historical operating data; and determining by multi-factor combination optimization method.

Clearly defining the life-extending low-temperature range can precisely control the battery's operating environment, which helps to slow down battery aging, extend battery life, and provide quantifiable optimization basis for different battery types.

Optionally, an electric fan can be additionally installed in the air duct. The electric fan can actively promote airflow when there is a lack of natural wind or relative airflow, so as to maintain the heat dissipation capacity of the air duct.

Optionally, the cooling and life-extending device can be configured with a multi-stage cooling strategy: primary cooling is achieved by the cooling system and air duct in conjunction with natural wind or relative airflow, without the need for additional energy consumption; secondary cooling is assisted by an electric fan; tertiary cooling is initiated by the refrigeration system to achieve cooling and temperature control under extreme high-temperature conditions; the multi-stage cooling strategy can be arbitrarily combined and switched by the control module to ensure that the cooling and life-extending device can adjust the temperature of the battery module as needed under any operating condition.

The multi-stage cooling strategy enables on-demand temperature control, ensuring that the battery is in the life-extending low-temperature range under different operating conditions, thereby improving system reliability and thermal management efficiency.

Optionally, the specific control measures that the integrated control module can take include, but are not limited to, dynamically adjusting the execution sequence, operating mode, operating parameters, and operating intensity of any functional unit or its sub-components or secondary components, or reconstructing or switching the topological connection structure of any functional unit or its sub-components, secondary components, and secondary components; enabling the battery module to achieve temperature balance and maintain it in the life-extending low-temperature range under different operating conditions, thereby stabilizing the life-extending effect; and also configuring a series of controllable components in the cooling and life-extending device to achieve flexible adjustment as needed.

Optionally, any functional unit or its sub-components or secondary components can be quickly connected through multi-way valves, quick-connect pipes, bypass circuits, or quick-switching interfaces; This allows the integrated control module to dynamically adjust the execution sequence, operating mode, operating parameters, and operating intensity of any functional unit or its sub-components, secondary components, and secondary components, or to reconstruct or switch the topological connection structure of any functional unit or its sub-components, secondary components, and secondary components.

The dynamic adjustment and rapid reconfiguration capabilities of the temperature control module enable the battery to achieve temperature balance under various operating conditions.

Optionally, any functional unit or its sub-components or secondary components can be arranged in a coordinated manner for different parts of the battery module and work in coordination according to the zones to achieve differentiated heat dissipation and local temperature control, thereby improving the overall thermal management performance.

Optionally, any functional unit or its sub-components or secondary components can be integrated with the battery module to make the heat dissipation structure closely integrated with the battery module, thereby achieving centralized heat dissipation and overall temperature control, and further improving the compactness and heat dissipation efficiency of the device.

Optionally, the cooling and life-extending device is equipped with partitions to divide the battery module into multiple independent module compartments to form a modular thermal management structure, and to isolate the fault when a single module malfunctions, so as to avoid the risk from spreading to other modules.

Optionally, any functional unit or its sub-components or secondary components can be designed in a branched manner to disperse heat dissipation for different parts of the battery module and improve temperature uniformity.

Optionally, any functional unit or its sub-components or secondary components can be repeatedly configured as needed to achieve fault redundancy, so that when some units fail, other units can take over the operation to ensure system stability; at the same time, heat dissipation can be enhanced by adding parallel radiator units to improve the overall heat dissipation capacity; and hierarchical control can be achieved by hierarchical start-stop and adjustment of multiple units, so as to take into account both energy efficiency and precise control.

Through partitioning and branching design, the present invention can achieve precise temperature control and temperature balance for different parts of the battery module, significantly improving the overall performance and lifespan of the battery. At the same time, redundant configuration and redundant units ensure that the system can still operate stably when some functions fail, and achieve energy efficiency optimization and precise heat dissipation control through graded start-stop.

Optionally, the functional unit of the cooling and life-extending device further includes an anti-condensation module; the anti-condensation module can be automatically activated when the battery module temperature is close to the dew point to reduce the humidity of the air around the battery module, so that the dew point is lower than the battery surface temperature, thereby preventing condensation on the battery surface and ensuring the safe operation of the battery.

The anti-condensation module can effectively prevent condensation on the battery surface, reduce safety risks caused by humidity, and ensure stable operation of the battery in low-temperature or high humidity environments. At the same time, this function improves the reliability of the battery system.

Optionally, any functional unit or its sub-components or secondary components can be subjected to thermal connection interactively as needed, thereby improving the heat exchange efficiency between functional units and optimizing the overall system's heat dissipation performance; This thermal connection can achieve rapid heat exchange directly by connecting any functional unit or its sub-components or secondary components, or it can achieve indirect heat conduction by arranging heat exchange plates, heat dissipation fins, heat pipes, thermal bridges, heat conduction pipelines, or using heat exchange media (such as liquid cooling media or phase change materials) between any functional unit or its sub-components or secondary components; Alternatively, any functional unit or its sub-components or secondary components can also be equipped with thermal insulation structures as needed to block unwanted thermal connection; Various methods, including thermal insulation boards, thermal insulation jackets, air layers, low thermal conductivity materials, or insulation layers, can be used to slow down heat transfer, thereby preventing localized overheating while maintaining necessary heat exchange efficiency, and improving system safety and temperature uniformity; The two design methods (thermal connection/thermal insulation) can be selected independently without conflict.

Through the flexible design of thermal connection and insulation, the present invention improves the heat exchange efficiency between functional units while preventing local overheating.

Optionally, any functional unit or its sub-components or secondary components can adopt a modular design concept as needed to form independent modules. Through flexible pipelines, quick connectors and standardized interfaces, a structure that is easy to couple and disassemble can be achieved, so that each unit can be disassembled for cleaning or replacement, thereby reducing maintenance costs and downtime, improving the maintainability and adaptability of the system, and facilitating flexible configuration and upgrading; or, any functional unit or its sub-components or secondary components can also adopt an integrated design as needed, coupling any functional unit or its sub-components or secondary components into an overall structure, improving the heat exchange efficiency between them, reducing heat loss, improving thermal management efficiency, shortening pipelines, and improving structural compactness; these two design methods (modular design/integrated design) can be selected independently and do not conflict with each other.

Modular design improves the maintainability, flexible configuration and upgrade adaptability of the system, making it easy to disassemble, clean or replace, reducing maintenance costs and downtime; while integrated design enhances the heat exchange efficiency between functional units and improves structural compactness.

Optionally, the air duct can be configured as a multi-stage diversion structure or a parallel channel structure to realize the flow distribution and convergence of air and path selection, so that the air flows sequentially or separately through any of the functional units or their sub-components and secondary components and exchanges heat with them, thereby optimizing air distribution, improving heat dissipation uniformity and reducing wind resistance.

Optionally, the air duct can adopt an automatic switching structure or an adjustable opening structure, which can dynamically adjust the air flow path or opening size according to the needs to optimize wind resistance and heat dissipation efficiency.

Optionally, the air duct can be equipped with a guide plate (adjustable), an adjustable baffle (servo driven), a vortex generator, a damper (variable opening), louvers or adjustable blades to improve the airflow path, reduce dead zones or local hot spots, and adjust the airflow direction and flow rate as needed.

Optionally, the electric fan includes a variable speed control or stepless wind speed control fan, and can further include variable pitch blades or a bidirectional impeller structure, so as to automatically adjust the air volume and blade angle according to the demand, thereby improving energy efficiency and heat dissipation efficiency.

The multi-stage diversion and adjustable air duct design optimizes the airflow path, improves heat dissipation uniformity and reduces wind resistance. At the same time, through the active adjustment of the adjustable guide plate, damper and electric fan, efficient heat dissipation and energy efficiency optimization under different working conditions are achieved, ensuring stable operation of the battery module.

Optionally, the electric fan includes a low-resistance operating structure, the low-resistance operating structure is used to allow the fan to rotate freely with the airflow direction in a high-speed airflow scenario, so as to reduce air resistance and enhance the convective ventilation effect of the radiator.

Optionally, the low-resistance operating structure includes at least one of the following: a non-reverse drag control circuit, a one-way clutch mechanism, a low-resistance bearing structure, a magnetic levitation bearing structure, or an automatic stop/retract blade structure.

Optionally, the non-reverse drag control circuit is used to suppress the reverse electric resistance generated by the motor when the fan blades are driven to rotate by high-speed airflow; the one-way clutch mechanism is used to achieve free rotation under the action of high-speed airflow, while being driven by the motor in low-wind-speed scenarios; the low-resistance bearing structure is used to reduce the rotational friction of the fan in the follow-up state; the magnetic levitation bearing is used to further reduce mechanical friction loss; the automatic stop or blade retraction structure is used to separate the fan from the airflow when the high-speed airflow is sufficient to meet the heat dissipation requirements, thereby further reducing air resistance and improving the overall heat dissipation efficiency.

The low-resistance operating fan can rotate freely with the airflow when running at high speed, reducing air resistance and enhancing natural ventilation. At the same time, a variety of low-friction and automatic adjustment structures improve heat dissipation efficiency and system energy efficiency.

Optionally, any functional unit or its sub-components or secondary components can be equipped with a temperature equalization device to improve the overall temperature uniformity and thermal response efficiency of the functional unit.

Optionally, any functional unit or its sub-components or secondary components can be covered with phase change material to freeze and store cold energy when the battery module load is low or the ambient temperature is low at night, and melt and release cold energy when the temperature rises during the day or the battery module load suddenly increases, thereby reducing the start-up frequency of the refrigeration system and achieving cross-day and cross-seasonal temperature control optimization; the phase change material can be precisely controlled by alloy formula optimization or microcapsule encapsulation technology to meet the precise temperature control requirements under different application scenarios.

Optionally, the phase change material can be used in a graded array or deployed in different locations in a graded manner to achieve a graded phase change process through a combination of multiple melting points, and store and release cold energy at different temperature points or different locations, thereby enhancing the ability to maintain and regulate low-temperature.

The combination of the temperature equalization device and the phase change material improves the temperature uniformity and thermal response efficiency. At the same time, by storing and releasing cold energy, the temperature control optimization is achieved across day and night and across seasons, reducing the start-up frequency of the refrigeration system.

Optionally, the cooling and life-extending device is also equipped with a heat preservation system; When the ambient temperature is too low, the heat preservation system can quickly reduce the heat exchange efficiency of any functional unit or its sub-components or secondary components to prevent the battery module temperature from being too low; If necessary, the heat preservation system can activate an electric heating unit, a small reversible heat pump or other compensating heating device to perform compensating heating, thereby ensuring that the battery module temperature is stable in the life-extending low-temperature range rather than in an overcooled state.

Optionally, the cooling system further includes a bypass circuit. When the heat load of the battery module is small, the coolant can bypass the radiator and return directly to the cooling plate through the bypass circuit, thereby keeping the coolant temperature from being too low and preventing the battery module from being in an overcooled state.

Optionally, the anti-condensation module can also monitor the surface temperature of the battery module, the temperature of the coolant and the ambient humidity in real time, and judge the risk of condensation according to the condensation model or threshold, thereby controlling the heating device to heat the surface of the battery module or the surrounding air, or reducing the air humidity or increasing the air circulation through the air conditioning device, thereby inhibiting water vapor condensation, ensuring the safe operation of the system in a low-temperature and high humidity environment, and without affecting the low-temperature life-extending effect.

The heat preservation system, bypass circuit and anti-condensation module work together to prevent the battery from getting too cold and condensation on the surface, and keep the battery temperature stable in the life-extending range.

Optionally, the cooling and life-extending device further includes a thermosiphon circuit or a heat pipe array, which connects the battery cold plate and the radiator, and achieves partial or complete pump-free natural circulation cooling under the temperature difference drive, so that the coolant can complete the circulation without relying on the water pump, thereby still having basic low-temperature maintenance capability when the pump fails.

Optionally, the device is equipped with redundant control logic: when the cooling and life-extending device cannot effectively reduce the battery temperature to the low-temperature operating range (e.g., radiator failure, coolant pump failure, insufficient fan speed or excessively high ambient temperature), the redundant control logic will automatically switch to the overheat protection mode to prioritize ensuring that the battery module does not overheat, thereby improving system reliability and preventing thermal runaway.

The heat preservation system, bypass circuit and anti-condensation module work together to prevent the battery from getting too cold and condensation on the surface, and keep the battery temperature stable in the life-extending range.

Optionally, any functional unit or its sub-components or secondary components can be linked with the vehicle's powertrain, BMS, or onboard air conditioning system to switch heat dissipation strategies according to operating conditions, thereby achieving optimized temperature control for the entire vehicle.

Optionally, the condenser shares part of the refrigeration system with the vehicle's original air conditioning system to reduce system redundancy, lower costs and improve refrigerant circulation efficiency; However, the cooling and life-extending device can also be equipped with an evaporator and control valve independently, so that it can operate independently when the battery module needs low-temperature control, thus not affecting the comfort of the passenger compartment.

Optionally, the cooling and life-extending device can also integrate heat recovery function to use the heat generated by the battery module for vehicle cabin or auxiliary heating.

Optionally, the cooling and life-extending device can also be equipped with a damping or noise reduction device to reduce noise.

The cooling and life-extending device is linked with the vehicle's powertrain, BMS, and air conditioning system to achieve optimized temperature control throughout the vehicle. At the same time, it shares the refrigeration system and independently controls the evaporator, balancing cost and comfort. The integrated heat recovery and noise reduction design further improves energy efficiency, system reliability, and passenger experience.

Optionally, the radiator adopts a variable fin spacing structure; Under normal circumstances, the fin spacing is small to improve heat exchange efficiency; In dusty or polluted environments, the fin spacing can be increased to reduce the risk of blockage, thereby maintaining a long-term stable low-temperature heat dissipation effect.

Optionally, any functional unit or its sub-components or secondary components can also be equipped with a spray cooling device, which can further enhance heat dissipation efficiency through spray evaporation and heat absorption in ultra-high temperature or continuous high load scenarios.

Optionally, the cooling and life-extending device can also be equipped with an elevated heat dissipation tower, and any functional unit or its sub-components or secondary components can be preferentially installed in the elevated heat dissipation tower.

Optionally, the elevated heat dissipation tower can be equipped with a shield, air guide plate, dust filter chamber and sealing protection structure, and can form an air film or air curtain through a fan, nozzle or air guide plate to reduce the direct entry of ground dust and reduce the impact of windward dust on the heat dissipation tower.

Optionally, the elevated heat dissipation tower can also ensure smooth airflow by rationally arranging the airflow guide structure and optimize the airflow guide in combination with the vehicle movement direction, thereby maintaining the long-term stable and efficient heat dissipation performance of the cooling and life-extending device.

The variable-pitch radiator and spray cooling device improve the heat dissipation efficiency and reliability of the system under different environments and high loads. The elevated heat dissipation tower and protective design effectively reduce the impact of dust, optimize air circulation, and achieve long-term stable and efficient battery temperature control.

Optionally, the elevated heat dissipation tower can be equipped with multiple axial flow fans, which can be controlled by frequency conversion or constant speed, and have a back-blowing dust removal function. The dust on the surface of the fins and pipes is removed by periodic or real-time reverse airflow. At the same time, it can be used with airflow guide plates to optimize the airflow path and reduce the risk of dust accumulation in dead corners.

Optionally, the elevated heat dissipation tower can be supplemented with sound waves or ultrasonic vibrations to actively shake off the attached dust, and in special cases, it can be combined with slight spray atomization pretreatment to make some dust settle in the pretreatment area to ensure long-term stable heat dissipation performance.

Optionally, the elevated heat dissipation tower can flexibly adjust the fan frequency and airflow direction according to the concentration of mineral dust, operating environment and seasonal changes, so as to achieve environmentally adaptive dust control.

Optionally, the fin spacing of the radiator can be appropriately increased, and the structural design can include trapezoidal, corrugated or spiral, and anti-stick powder or hydrophobic coating can also be applied to reduce dust adhesion and clogging.

Optionally, a dust removal device can be installed at the air inlet or air channel of the cooling and life-extending device, including but not limited to a filter screen, a washable filter element, a composite filter element, a microporous filter layer, a cyclone separator or an electrostatic dust collection device, to classify and intercept dust according to its size or electrical properties.

The vibration shaking, spray pretreatment, and environmental adaptive wind control of the elevated heat dissipation tower can effectively prevent dust and ensure long-term stable heat dissipation. Combined with the optimized fin design and multi-stage dust removal device, dust adhesion and clogging are further reduced, improving the reliability and lifespan of the battery temperature control system in complex environments.

Optionally, the cooling and life-extending device can be equipped with a dust sensor to monitor the dust concentration in the air in real time, and automatically trigger back-blowing, vibration cleaning or spray washing functions according to the actual situation.

Optionally, the cooling and life-extending device can also achieve intelligent dust management by adjusting the fan adjustment strategy, optimizing the airflow structure, selecting the fin spacing, combining materials, and working together with various dust prevention measures to ensure heat dissipation efficiency and extend the device's lifespan.

Optionally, the cooling and life-extending device can also flexibly adjust its operating strategy according to the concentration of mine dust, operating environment and seasonal changes, and record cleaning logs to optimize the maintenance cycle and reduce maintenance costs.

The combination of dust sensing and intelligent dust prevention management enables the radiator to adapt to the environment for dust cleaning and maintenance, ensuring long-term efficient heat dissipation.

Optionally, the internal and external operating parameters that can be monitored by the integrated control module include, but are not limited to, the temperature and temperature difference, flow rate and flow rate difference, pressure and pressure difference, liquid level, air velocity, wind pressure, airflow direction and wind speed difference of any functional unit, its sub-component or secondary component at any measuring point or location, and any difference between these measuring points or locations, such as the difference between different measuring points within the same functional unit, sub-component or secondary component, or the difference between different measuring points in different functional units, sub-components or secondary components, as well as the derived quantities calculated from the above parameters; and also include, but are not limited to, the operating status of the battery module (such as battery heat generation, single cell and module temperature, state of charge SOC/DOI, charging and discharging power, cycle number, health status), vehicle operating status (such as vehicle speed, acceleration, braking status, steering status, load, driving mode) and environmental conditions (such as ambient temperature, humidity, air pressure, wind direction and wind speed, solar radiation intensity).

Optionally, the controllable components include, but are not limited to, adjustable speed electric pumps, adaptive pumps, micro circulation pumps, bidirectional pumps, electronic control valves, three-way valves, four-way valves, eight-way valves, multi-way valves, flow dividers, switching valves, multi-way switching valves, throttling devices, solenoid valves, adjustable throttling valves, differential pressure regulating valves, compressors (variable frequency compressors, twin-rotor compressors, or scroll compressors), turbo expanders, adjustable condenser brackets, heat exchanger bypass valves, cooling plate adjustment components, heat pipe control switches, phase change material start/stop control devices, intelligent control modules, power drive units, non-reverse drag control circuits, and automatic stop or folding blade mechanisms.

The temperature control module comprehensively monitors internal operating parameters and external performance parameters, and combines multiple controllable components to achieve closed-loop intelligent control of local and overall thermal balance, thereby improving battery temperature control accuracy, system response speed and operational reliability, while optimizing energy efficiency and life-extending effects.

Optionally, the decision control algorithm includes, but is not limited to, predetermined strategies, adaptive methods, predictive methods, fuzzy control, PID control, model predictive control (MPC), reinforcement learning, neural networks, generative large models and other data-driven or physical model-based optimization control methods, or a combination of these algorithms.

Optionally, any functional unit or its sub-components or secondary components can be made of a variety of materials, including but not limited to metals (aluminum alloys, copper, stainless steel, carbon steel with anti-corrosion treatment, titanium alloys, magnesium alloys), plastics or polymer materials (polyethylene PE, cross-linked polyethylene PEX, polyurethane PU foam tubes, polypropylene PP, polyvinylidene fluoride PVDF, polytetrafluoroethylene PTFE, chlorinated polyvinyl chloride CPVC), high thermal conductivity plastics (graphite-filled polypropylene, thermally conductive nylon, carbon fiber reinforced PEEK), composite materials (glass fiber reinforced plastic FRP, carbon fiber reinforced materials, aramid fiber composite materials), metal-ceramic composite pipes, high thermal conductivity concrete-coated pipes, ceramic pipes, ceramic coating materials (alumina ceramics, silicon nitride ceramics, metal-ceramic composite coatings), graphene composite materials, carbon nanotube composite polymers and nano-aerogel thermal insulation composite layers.

Any functional unit or its sub-components or secondary components can be equipped with a heat exchange medium. The heat exchange medium can be a gaseous medium, a liquid medium, a phase change medium or a refrigeration medium. Specific types include, but are not limited to, water, deionized water, ethylene glycol aqueous solution, propylene glycol aqueous solution, liquid nitrogen, liquid helium, organic solvents, inorganic solvents, environmentally friendly Freon refrigerants, compressed air, nitrogen, carbon dioxide, and ammonia. The medium can be used alone or its thermal management performance can be optimized through mixing or circulation.

Diverse control algorithms provide comprehensive support for temperature regulation, from rule-driven to intelligent learning, enabling the system to have higher adaptability and optimization capabilities, and combining the flexible selection of a variety of high-performance materials and heat exchange media.

Optionally, the battery module can be in the form of a single cell, a battery unit formed by combining several single cells, a battery pack, a battery cluster or other modular unit, and the structural form can be stacked, layered, honeycomb, grid, ring, matrix, three-dimensional arrangement, flexible battery array, folded structure, modular splicing structure, to meet the capacity, power and volume requirements of different application scenarios, or to adapt to the requirements of space-constrained or scalable devices; the shape of the battery module can be cylindrical, square, rectangular, flat sheet, sheet stack, ring, elliptical, polygonal, prism, triangular, rollable flexible sheet, or a modular geometric structure formed by combining cells, to achieve flexible arrangement and assembly; the packaging form of the battery module can be in the form of a metal shell, plastic shell, composite material shell, soft pack, modular shell, waterproof and dustproof seal, heat dissipation enhancement, embedded packaging, surface coating packaging, or other packaging solutions that can provide environmental protection, thermal management and mechanical strength.

The diverse battery module forms, structures, and packaging methods enhance the system's flexibility in terms of capacity, power, space adaptability, and environmental protection. This design not only meets the needs of different application scenarios but also enhances the battery's overall performance in thermal management and mechanical strength.

Optionally, the battery module can be any electrochemical device suitable for energy storage and release, including but not limited to lithium batteries (such as lithium-ion, lithium iron phosphate, ternary materials, lithium-sulfur and polymer lithium batteries), sodium batteries (sodium batteries, sodium-ion batteries), aluminum batteries (aluminum batteries, aluminum-ion batteries), magnesium batteries and their ion batteries, graphene-based batteries, sulfur batteries, nickel-metal hydride batteries, lead-acid batteries, all-solid-state batteries, solid-liquid hybrid batteries, metal and metal-ion batteries, air batteries, fuel cells, halide batteries, silicon-based batteries, supercapacitors, or other similar energy storage devices, so that the battery module can achieve efficient, safe and reliable energy supply in energy systems and other applications.

Optionally, the upper limit of the life-extending low-temperature range can be directly selected from the temperature values listed below (including but not limited to), or arbitrarily selected within a ±2.5° C. range of the following temperatures: −30° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.; The lower limit of the life-extending low-temperature range can be directly selected from the temperature values listed below (including but not limited to), or arbitrarily selected within a ±2.5° C. range of the following temperatures: −27.5° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.

Optionally, the specific melting point values of the phase change material include, but are not limited to, 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., and −25° C., and can be finely adjusted within a ±2.5° C. range of the listed values.

This solution is compatible with a variety of electrochemical energy storage devices, and combined with a flexible and adjustable life-extending low-temperature range and a melting point setting for phase change materials, the system can adapt to different battery chemical systems and application scenarios.

Optionally, the form of the temperature equalization device includes, but is not limited to, microchannel liquid cooling plate, liquid cooling temperature equalization plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange and aerogel insulation-thermal conductive composite structure.

The diverse forms of temperature equalization devices provide flexible options for different operating conditions, effectively improving the temperature uniformity and thermal response speed of the battery module. The combination of its multi-stage heat conduction and heat exchange methods can also enhance heat dissipation efficiency and system reliability while ensuring safety.

This invention aims to solve the economic and safety issues of batteries throughout their entire life cycle through a disruptive technological concept. Traditional thermal management technology only focuses on maintaining the battery temperature at room temperature to avoid overheating or overcooling. However, through long-term experiments, the inventors have discovered that various types of batteries can significantly extend their lifespan by three to four times in low-temperature environments. This discovery completely changes the existing concept, upgrading the core design goal from “safe temperature management” to “low-temperature life-extending management,” actively utilizing the low-temperature environment to extend battery life.

To achieve this goal, the present invention overcomes the challenges of increased energy consumption, capacity loss, and design complexity that can result from low-temperature operation. Through a comprehensive strategy of multi-stage cooling, intelligent temperature control, and capacity redundancy, the present invention designs a highly efficient cooling and life-extending system. This system can dynamically adjust the cooling intensity, minimizing energy consumption while ensuring life-extending effects. In addition, the system has high reliability and can effectively cope with extreme operating conditions. Through modular design, dust prevention, and anti-clogging measures, it ensures long-term stable operation even under high load, high temperature, or high dust environments. At the same time, the combination of capacity redundancy and intelligent temperature control can compensate for capacity loss caused by the decrease in chemical reaction rate at low-temperatures, ensuring the battery's range and power output stability.

Compared with the prior art, the present invention has significant inventiveness and overwhelming advantages. It not only achieves a leap from passive management to active optimization in terms of technical concept, but also proposes a completely new solution in system design and functional implementation. By unifying low-temperature life-extending with energy efficiency optimization, the present invention significantly extends battery life throughout its entire life cycle, reduces operating costs, and brings economic benefits and industrial application value that cannot be achieved by the prior art. This innovation, which fundamentally improves battery performance and economy, provides an unprecedented technological breakthrough for fields such as electric vehicles and electric transportation equipment.

### BRIEF DESCRIPTION OF DRAWINGS

FIG. 1 is a schematic diagram of a cooling and life-extending device applicable to electric transportation equipment and its auxiliary facilities according to some embodiments of the present disclosure.

FIG. 2 is another schematic diagram of a cooling and life-extending device applicable to electric transportation equipment and its auxiliary facilities according to some embodiments of the present disclosure.

FIG. 3 is another schematic diagram of a cooling and life-extending device applicable to electric transportation equipment and its auxiliary facilities according to some embodiments of the present disclosure.

FIG. 4 is another schematic diagram of a cooling and life-extending device applicable to electric transportation equipment and its auxiliary facilities according to some embodiments of the present disclosure.

FIG. 5 is another schematic diagram of a cooling and life-extending device applicable to electric transportation equipment and its auxiliary facilities according to some embodiments of the present disclosure.

FIG. 6 shows the original experimental data to demonstrate the low-temperature life-extending effect of this case.

Cooling system 101, air duct 102, coolant pump 401, radiator 402, cooling plate 403, cooling pipe 404, battery module 405, refrigeration system 103, condenser 501, compressor 502, throttling device 503, evaporator 504, refrigeration pipe 505.

### DETAILED DESCRIPTION OF THE INVENTION

The embodiments of the present invention are described below with reference to the accompanying drawings. These descriptions are merely illustrative and not limiting, intended to help those skilled in the art understand the scope and effects of the invention. The present invention can be implemented in various forms; the embodiments provided herein are for illustration only and not limitation. Unless otherwise specified, component arrangements, materials, parameters, and values are exemplary, and terminology should be interpreted according to the ordinary understanding of those skilled in the art, rather than idealized or overly formalized. Known technologies, methods, and devices are not described in detail, but their application can be understood in conjunction with this specification. The embodiments are merely illustrative; details can be modified, substituted, or adjusted without departing from the core concept, and those skilled in the art can understand other advantages and applications of the present invention accordingly. The technical features of the present invention can be used individually or in combination, all of which fall within the scope of protection. The accompanying drawings are for illustrative purposes only; the number, size, shape, and proportion of components can be adjusted or replaced as needed without affecting the purpose and effects of the present invention. The present invention is applicable to the illustrated and other similar scenarios, and improvements to functional modules and control methods are also included within the scope of protection. In summary, the embodiments are only used to illustrate the technical solutions and effects, and are not intended to limit the scope of protection. Any equivalent substitutions or improvements made without departing from the core concept should be considered to fall within the scope of protection of this invention, which is defined by the claims. The specification and drawings are only used to explain the principles and effects.

The technical solution of the present invention can be implemented alone or in combination with other cooling methods, temperature control strategies or components. Although the specification describes low-temperature life-extending strategies, cooling systems, air ducts and intelligent temperature control solutions with reference to specific embodiments, its core is “extending battery life and optimizing system performance through low-temperature control”. As long as the implementation scheme achieves this core objective, even if the specific structure, parameters or components are adjusted, it should still be considered to fall within the protection scope of the present invention. The present invention not only covers specific implementation methods, but also includes equivalent technical solutions without departing from the core concept of life-extending, providing a technical basis for electric vehicles and electric transportation equipment to achieve performance improvement and economic optimization throughout their entire life cycle. The scope of application includes electric vehicles, transportation tools and special equipment that use batteries as the main power source.

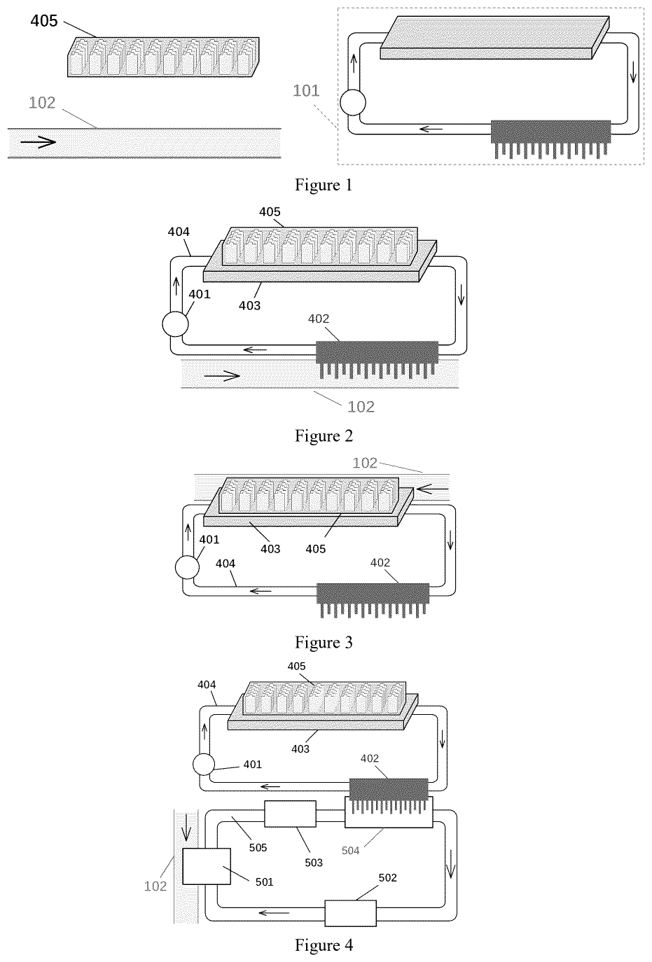

FIGS. 1 to 3 are schematic diagrams of a cooling and life-extending device applicable to electric transportation equipment and its auxiliary facilities according to some embodiments of the present disclosure. In some embodiments, as shown in FIG. 1, the cooling and life-extending device includes several functional units, sub-components and secondary components. The functional units can include, but are not limited to: battery module 405, cooling system 101, and air duct 102;
The sub-components of the cooling system 101 include a coolant pump 401, a radiator 402, a cooling plate 403, and interconnected cooling pipes 404;
The air duct 102 defines the airflow path, allowing air to flow through the radiator 402, and the air is finally discharged to the outside after heat exchange.
The cooling and life-extending device can stably control the temperature of the battery module 405 within the life-extending low-temperature range, thereby extending the life of the battery module 405 and significantly enhancing its economic efficiency throughout its entire life cycle.
The life-extending low-temperature range is a low-temperature range below room temperature but above the dew point. When the battery module 405 is used for a long time within this life-extending low-temperature range, it can slow down the aging and degradation of electrode materials and electrolyte, thereby extending its lifespan.
The cooling system 101 contains circulating coolant. As shown in FIG. 2, the coolant pump 401 drives the coolant to circulate within the cooling system 101. The cooling plate 403 is in close contact with the battery module 405 that needs cooling, enabling the coolant to efficiently absorb the heat generated by the battery module 405 during operation. The coolant is transported to a radiator 402 via cooling pipes 404, where the radiator 402 exchanges heat with the air through convection. The cooled coolant then flows back to the cooling plate 403, achieving a continuous and stable cooling effect. The cooling plate can also be in close contact with other sub-components or secondary components that need cooling to achieve the purpose of cooling.
The battery module 405 undertakes the core functions of energy storage and output, and is the core component of the electric transportation equipment and its auxiliary facilities. It is also the direct cooling target and life-extending carrier of the cooling and life-extending device.
The functional unit refers to the overall module in the cooling and life-extending device used to realize the main function. The sub-component refers to the subdivided structure or independently operable component under the functional unit. The secondary component refers to the specific element or hardware component after the sub-component is further subdivided.

As shown in FIG. 2, the air duct 102 can limit the air flow path and make the air flow through the radiator 402.

In this invention, the life-extending low-temperature range refers to the temperature range below the ambient reference temperature but still above the critical temperature at which water vapor in the air begins to condense. The ambient reference temperature can be set according to different application requirements; for example, 20° C., 25° C., or 30° C. can be selected as a reference value. The critical temperature can be obtained using known dew point calculation methods. For example, when the ambient reference temperature is set to 25° C. and the relative humidity is 60%, the corresponding critical temperature is approximately 16° C., and the life-extending low-temperature range can be determined to be 16° C. to 25° C. Through this definition, those skilled in the art can flexibly determine suitable temperature ranges under different environmental conditions, thereby ensuring the operability and universality of this invention.

In some embodiments, the cooling and life-extending device is used to actively promote the temperature reduction of the battery module and maintain it in the life-extending low-temperature range, rather than just to prevent thermal runaway; the functional unit of the cooling and life-extending device can be replaced with other structures, or combined with other structures to achieve the above-mentioned purpose of cooling and life-extending; the functional unit can also select to implement any of the following temperature control strategies according to specific needs: passive heat dissipation, air cooling, convection cooling, active cooling or thermal compensation, or select a combination of multiple strategies to construct a multi-stage coupled temperature control system.

In some embodiments, the air duct can also cause air to flow through any functional unit or its sub-components or secondary components and exchange heat with them, thereby enhancing the overall heat dissipation effect of the cooling and life-extending device.

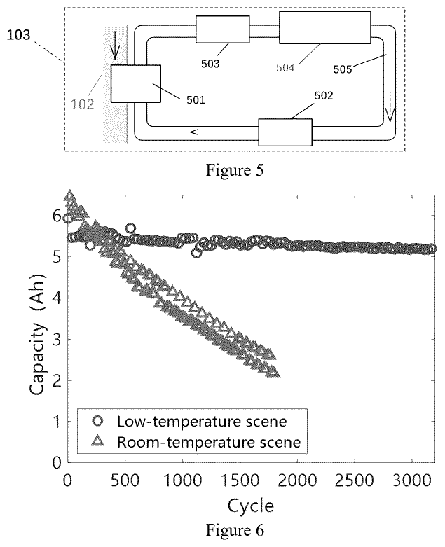

As shown in FIG. 3, the air duct 102 can define the airflow path and allow air to flow through the cooling plate 403. FIG. 4 and FIG. 5 are schematic diagrams of a cooling and life-extending device applicable to electric transportation equipment and its auxiliary facilities according to some embodiments of the present disclosure.

In some embodiments, the functional unit of the cooling and life-extending device further includes: a refrigeration system 103.

In some embodiments, as shown in FIG. 5, the sub-components of the refrigeration system 103 include a condenser 501, a compressor 502, a throttling device 503, an evaporator 504, and interconnected refrigeration pipes 505.

In some embodiments, the refrigeration system 103 contains a refrigerant; the refrigerant circulates and undergoes a phase change within the refrigeration system 103, and exchanges heat with each sub-component of the refrigeration system 103 in sequence.

In some embodiments, the refrigeration system 103 is activated when the ambient temperature is too high or the heat dissipation efficiency of the cooling system 101 is insufficient to reduce the coolant to the target temperature, so as to further enhance the heat dissipation effect of the cooling and life-extending device and ensure that the battery module 405 is in the life-extending low-temperature range.

As shown in FIG. 4, in some embodiments, the compressor 502 compresses the low-pressure gaseous refrigerant into a high-temperature and high-pressure gas, which is then sent to the condenser 501 through the refrigeration pipe 505 to release heat and condense it into a liquid; subsequently, the refrigerant enters the evaporator 504 after being depressurized and cooled by the throttling device 503, where it absorbs heat and evaporates into a gas, and then returns to the compressor 502 to form a cyclic refrigeration process; wherein, the condenser 501 is coupled with the air duct 102, and the heat released by the refrigerant in the condenser 501 is transferred through the air duct 102 and finally discharged to the outside; the evaporator 504 is coupled with the radiator 402 (or other components) in the cooling system 101, and the refrigerant absorbs heat in the evaporator 504, thereby reducing the temperature of the radiator 402 in the cooling system 101 and achieving auxiliary cooling of the coolant.

In some embodiments, the throttling device 503 is preferably a thermostatic expansion valve or an electronic expansion valve, or it can be a capillary tube, a float valve, a needle valve, an electronic proportional valve, a two-stage expansion valve or an adjustable orifice capillary tube, etc., which can adjust the refrigerant flow according to the load of the evaporator 504 or the system control requirements, thereby ensuring the stable heat absorption and circulating cooling effect of the evaporator 504.

In some embodiments, each functional unit, sub-component and secondary component in the cooling and life-extending device is optional, wherein the electrically related parts have a sealed structure to suppress condensation and improve adaptability under low-temperature conditions.

In some embodiments, when the battery module operates in the life-extending low-temperature range, although its lifespan can be extended, its electrochemical reaction rate is reduced, resulting in a reduction in initial capacity; therefore, the battery module is configured with a capacity redundancy function.

In some embodiments, the capacity redundancy function is achieved by pre-setting additional redundant capacity for the battery module to compensate for the capacity loss of the battery module when operating in a low-temperature environment; the capacity redundancy function is an optional configuration.

In some embodiments, the capacity redundancy function can be achieved by adding a battery expansion pack and cooperating with the battery module to achieve excess redundancy; or by designing the total capacity of the battery module according to a preset redundancy ratio to achieve excess redundancy design from the source of the solution.

In some embodiments, the capacity redundancy function can selectively enable or disable the battery expansion pack according to external load demand, or automatically adjust the overall operating intensity of the battery module, so that the total capacity of the battery module can flexibly meet the external load demand and can respond in a timely manner when the demand suddenly increases.

In some embodiments, the capacity redundancy function can not only compensate for the capacity loss of the battery module in the low-temperature life-extending range, but also further improve the life of the battery module on the basis of the life-extending caused by low-temperature.

Scenario 1, illustrating the effect of low-temperature life-extending: At room temperature of 30° C., the nominal capacity of the battery module is 1 Ah, and the cumulative charge-discharge life is 1000 Ah, then its equivalent cycle count is 1000 times (1000 Ah÷1 Ah). When operating in the low-temperature life-extending range of around 10° C., due to the effect of low-temperature life-extending, the cumulative charge-discharge life of the battery module can be extended to 3 times, that is, 3000 Ah. But at the same time, its capacity will decrease by 15%, becoming 0.85 Ah (1 Ah×0.85), at which time the equivalent cycle count is approximately 3529 times (3000 Ah÷0.85 Ah).

It can be seen that although the capacity decreases by 15% due to operation in the low-temperature range, the lifespan is increased to more than three times the original, achieving a significant gain effect. This technical feature of “exchanging a partial sacrifice of capacity for a multiple increase in lifespan” unexpectedly achieves the effect of “using four ounces to move a thousand pounds”. At the same time, combined with the application trend of unmanned vehicles, the relative loss of capacity can be made up by automatic energy replenishment, while the multiple extension of lifespan is the key to ensuring its long-term operational economy.

Scenario 2 illustrates the synergistic effect of low-temperature life-extending and capacity redundancy function: If the battery module is further configured with capacity redundancy function, the initial capacity can be increased to 1.1765 times, i.e., 1.1765 Ah, by increasing the number of cells. Under normal temperature conditions, its cumulative charge-discharge life is also increased to 1176.5 Ah (1.1765 Ah×1000 times). When operating in the low-temperature life-extending range of about 10° C., although there is a 15% capacity decrease, the redundant capacity can offset this adverse effect, and its actual capacity remains at 1 Ah (1.1765 Ah×0.85). At the same time, due to the low-temperature life-extending effect, its cumulative charge-discharge life is still increased three times to 3529 Ah (1176.5 Ah×3), and the equivalent number of cycles is 3529 (3529 Ah÷1 Ah).

It can be seen that by simply increasing the redundant capacity configuration by 0.1765 Ah, the capacity reduction can be avoided in low-temperature operation scenarios, and the lifespan can be extended by 3.529 times, which unexpectedly achieves a technological advancement that is “all benefits and no harm”.

In addition, the capacity redundancy function not only replenishes the capacity, but also extends the lifespan on the basis of the low-temperature life-extending effect: due to the effect of the low-temperature life-extending effect, the cumulative charge and discharge lifespan of the battery module in scenario 1 can be extended to 3 times to 3000 Ah; however, due to the synergistic effect of the low-temperature life-extending and the capacity redundancy function, the cumulative charge and discharge lifespan of the battery module in scenario 2 can be extended to 3 times to 3529 Ah; that is, the capacity redundancy function extends the cumulative charge and discharge lifespan of the battery module by 0.529 times.

In the low-temperature life-extending effect described herein, the life index is not limited to the cumulative charge and discharge amount, but can also include, but is not limited to: cumulative cycle number, cumulative charge amount, cumulative discharge amount, cumulative charge and discharge duration, cumulative driving mileage and other parameters that can characterize battery life.

It should be noted that the numerical values and calculation results mentioned above are for illustrative purposes only and do not constitute a limitation on the scope of protection of the present invention.

In some embodiments, the functional unit of the cooling and life-extending device further includes: an integrated control module.

In some embodiments, the integrated control module is also configured with a decision control algorithm, which can dynamically adjust the coolant flow rate, fan speed or start-up and shutdown of the refrigeration system according to the battery module temperature, coolant temperature and ambient temperature, or the load requirements of the battery module, so that the battery temperature is kept stable in the long-term life-extending low-temperature range; wherein, if the ambient temperature is too low, the coolant flow rate is reduced to avoid the battery being overcooled.

In some embodiments, the integrated control module can ensure that one or more operating characteristics of the battery module do not exceed the preset operating condition threshold during charging and discharging, so as to avoid the rapid increase of the side reaction rate of the battery module under adverse operating conditions.

In some embodiments, the operating characteristics include one or more of the following: charging current, charging voltage, discharging voltage, discharging current, charging and discharging power, temperature, and other battery operating condition parameters.

In some embodiments, when the integrated control module detects that one or more operating characteristics are close to or exceed the preset operating condition threshold, a protection mechanism will be triggered. The protection mechanism includes, but is not limited to: reducing the charging current, reducing the discharging current, reducing the charging and discharging power and/or voltage, performing a circuit breaker action, and issuing an alarm signal.

In some embodiments, the integrated control module can also monitor the internal and external operating parameters of the electric transportation equipment, its auxiliary facilities and the cooling and life-extending device in real time, then analyze the parameters through a decision control algorithm, and adjust the operating strategy and/or operating intensity of the cooling and life-extending device as needed based on the analysis results, so as to enhance the continuous temperature control capability and the precise temperature control capability.

In some embodiments, the life-extending low-temperature range can be around 10° C., around 15° C., around 20° C., or other temperature ranges below room temperature.

In some embodiments, the range of the life-extending low-temperature range and the setting of the preset operating condition threshold can vary depending on the type and model of the battery module, and can be affected by the chemical system, capacity, rated voltage and operating environment conditions of the battery module.

In addition, the operating condition threshold can be an upper limit protection (such as the temperature cannot be too high or the current cannot be too high), or a lower limit protection (such as the voltage cannot be too low), or a single-sided constraint (only an upper limit or a lower limit), or a double-sided constraint (both an upper limit and a lower limit).

In some embodiments, the life-extending low-temperature range and/or preset operating condition threshold can be determined through experiments, tests or a combination of those methods; specific determination methods include but are not limited to: determining by accelerated aging test, charge-discharge cycle test or thermal characteristic analysis; selecting based on experience or manufacturer recommendations; predicting by combining battery thermal management model, aging model or chemical kinetic simulation; performing statistical analysis based on historical operating data; and determining by multi-factor combination optimization method.

According to the experimental results, when setting the conditions for ternary lithium batteries, their life-extending low-temperature range can be set to 5° C. ˜15° C., their operating characteristics can be set as instantaneous charging current, and the preset operating condition threshold can be set to 1 C charging rate. This means that when a ternary lithium battery is running at 5° C. ˜15° C. and its instantaneous charging current does not exceed 1 C charging rate, its cycle life (or charge and discharge throughput life) will be extended by 3 times.

According to the experimental results, when setting the conditions for lithium iron phosphate batteries, their life-extending low-temperature range can be set to 0° C.˜10° C., their operating characteristics can be set as instantaneous charging current and instantaneous discharging current, and their preset operating condition threshold can be set as 3 C charging rate and 6 C discharging rate. This means that when lithium iron phosphate batteries operate at 0° C.˜10° C., and their instantaneous charging current does not exceed 3 C charging rate and their instantaneous discharging current does not exceed 6 C charging rate, their cycle life (or charge/discharge throughput life) can be significantly extended, for example, it can be extended to more than 10 times the original life. This data is only the test results in a specific embodiment and is used to illustrate the effect. It does not constitute a limitation of this disclosure.

In some embodiments, the overall control strategy under low-temperature operation scenarios is to ensure that the battery module operates under low-temperature conditions and reduce the charging and discharging current to slow down the side reaction rate and extend battery life. The limitation on charging current is usually stricter than that on discharging current. Furthermore, this strategy is not only applicable to ternary lithium batteries and lithium iron phosphate batteries, but can also be adjusted according to the characteristics of different battery chemical systems, thus possessing wide applicability and scalability.

In some embodiments, the cooling and life-extending device can be configured with a multi-stage cooling strategy: primary cooling is achieved by the cooling system and air duct in conjunction with natural wind or relative airflow, without the need for additional energy consumption; secondary cooling is assisted by an electric fan; tertiary cooling is initiated by the refrigeration system to achieve cooling and temperature control under extreme high-temperature conditions; the multi-stage cooling strategy can be arbitrarily combined and switched by the control module to ensure that the cooling and life-extending device can adjust the temperature of the battery module as needed under any operating condition.

In some embodiments, the specific control measures that the integrated control module can take include, but are not limited to, dynamically adjusting the execution sequence, operating mode, operating parameters, and operating intensity of any functional unit or its sub-components or secondary components, or reconstructing or switching the topological connection structure of any functional unit or its sub-components, secondary components, and secondary components; enabling the battery module to achieve temperature balance and maintain it in the life-extending low-temperature range under different operating conditions, thereby stabilizing the life-extending effect; and also configuring a series of controllable components in the cooling and life-extending device to achieve flexible adjustment as needed.

In some embodiments, any functional unit or its sub-components or secondary components can be quickly connected through multi-way valves, quick-connect pipes, bypass circuits, or quick-switching interfaces; This allows the integrated control module to dynamically adjust the execution sequence, operating mode, operating parameters, and operating intensity of any functional unit or its sub-components, secondary components, and secondary components, or to reconstruct or switch the topological connection structure of any functional unit or its sub-components, secondary components, and secondary components.

In some embodiments, any functional unit or its sub-components or secondary components can be arranged in a coordinated manner for different parts of the battery module and work in coordination according to the zones to achieve differentiated heat dissipation and local temperature control, thereby improving the overall thermal management performance.

Optionally, any functional unit or its sub-components or secondary components can be integrated with the battery module to make the heat dissipation structure closely integrated with the battery module, thereby achieving centralized heat dissipation and overall temperature control, and further improving the compactness and heat dissipation efficiency of the device.

Optionally, the cooling and life-extending device is equipped with partitions to divide the battery module into multiple independent module compartments to form a modular thermal management structure, and to isolate the fault when a single module malfunctions, so as to avoid the risk from spreading to other modules.

In some embodiments, any functional unit or its sub-components or secondary components can be designed in a branched manner to disperse heat dissipation for different parts of the battery module and improve temperature uniformity.

In some embodiments, any functional unit or its sub-components or secondary components can be repeatedly configured as needed to achieve fault redundancy, so that when some units fail, other units can take over the operation to ensure system stability; at the same time, heat dissipation can be enhanced by adding parallel radiator units to improve the overall heat dissipation capacity; and hierarchical control can be achieved by hierarchical start-stop and adjustment of multiple units, so as to take into account both energy efficiency and precise control.

In some embodiments, the functional unit of the cooling and life-extending device further includes an anti-condensation module; the anti-condensation module can be automatically activated when the battery module temperature is close to the dew point to reduce the humidity of the air around the battery module, so that the dew point is lower than the battery surface temperature, thereby preventing condensation on the battery surface and ensuring the safe operation of the battery.

In some embodiments, any functional unit or its sub-components or secondary components can be subjected to thermal connection interactively as needed, thereby improving the heat exchange efficiency between functional units and optimizing the overall system's heat dissipation performance; This thermal connection can achieve rapid heat exchange directly by connecting any functional unit or its sub-components or secondary components, or it can achieve indirect heat conduction by arranging heat exchange plates, heat dissipation fins, heat pipes, thermal bridges, heat conduction pipelines, or using heat exchange media (such as liquid cooling media or phase change materials) between any functional unit or its sub-components or secondary components; Alternatively, any functional unit or its sub-components or secondary components can also be equipped with thermal insulation structures as needed to block unwanted thermal connection; Various methods, including thermal insulation boards, thermal insulation jackets, air layers, low thermal conductivity materials, or insulation layers, can be used to slow down heat transfer, thereby preventing localized overheating while maintaining necessary heat exchange efficiency, and improving system safety and temperature uniformity; The two design methods (thermal connection/thermal insulation) can be selected independently without conflict.

In some embodiments, any functional unit or its sub-components or secondary components can adopt a modular design concept as needed to form independent modules. Through flexible pipelines, quick connectors and standardized interfaces, a structure that is easy to couple and disassemble can be achieved, so that each unit can be disassembled for cleaning or replacement, thereby reducing maintenance costs and downtime, improving the maintainability and adaptability of the system, and facilitating flexible configuration and upgrading; or, any functional unit or its sub-components or secondary components can also adopt an integrated design as needed, coupling any functional unit or its sub-components or secondary components into an overall structure, improving the heat exchange efficiency between them, reducing heat loss, improving thermal management efficiency, shortening pipelines, and improving structural compactness; these two design methods (modular design/integrated design) can be selected independently and do not conflict with each other.

In some embodiments, the air duct can be configured as a multi-stage diversion structure or a parallel channel structure to realize the flow distribution and convergence of air and path selection, so that the air flows sequentially or separately through any of the functional units or their sub-components and secondary components and exchanges heat with them, thereby optimizing air distribution, improving heat dissipation uniformity and reducing wind resistance.

In some embodiments, the air duct can adopt an automatic switching structure or an adjustable opening structure, which can dynamically adjust the air flow path or opening size according to the needs to optimize wind resistance and heat dissipation efficiency.

In some embodiments, the air duct can be equipped with a guide plate (adjustable), an adjustable baffle (servo driven), a vortex generator, a damper (variable opening), louvers or adjustable blades to improve the airflow path, reduce dead zones or local hot spots, and adjust the airflow direction and flow rate as needed.

FIG. 6 shows the original experimental data to illustrate the low-temperature life-extending effect of this case. The “Δ” symbol in the figure represents the battery degradation data in the normal temperature (25° C.) scenario. It can be observed that its initial capacity is relatively high (about 6.5 Ah), but it decays to about 2.5 Ah after about 1700 cycles. The “◯” symbol in the figure represents the battery degradation data in the low-temperature (15° C.) scenario. It can be seen that although its initial capacity is relatively low (about 5.5 Ah), it still basically maintains about 5.2 Ah after 3000 cycles, and the degree of decay is negligible. It can be seen that although low-temperature will lead to a decrease in the initial capacity of the battery, in the long run, its life benefit is significantly greater. On the other hand, the normal temperature scenario only has a capacity advantage in the early stage of degradation, and its life is significantly worse than that of the low-temperature scenario. In the current scenario of passenger cars, users mainly focus on the performance of the first 100,000 kilometers (equivalent to about 150 cycles, i.e., the advantageous cycle range of the battery under normal temperature conditions in FIG. 6). Therefore, manufacturers are more concerned about short-term performance and do not care about lifespan at all. However, as autonomous vehicles gradually become more widespread in the future, capacity loss can be compensated for by automatic replenishment (such as automatic charging or battery swapping), and the exponential extension of battery life is the key factor determining its long-term operating economy (FIG. 6 shows that there is still no significant degradation after about 1 million kilometers).

In some embodiments, an electric fan can be additionally installed in the air duct. The electric fan can actively promote airflow when there is a lack of natural wind or relative airflow, so as to maintain the heat dissipation capacity of the air duct.

In some embodiments, the air duct design can be aerodynamically styled. Scheme 1: Low-profile entry air duct, characterized by air entering from below the vehicle or side skirts at a low profile and being guided to the radiator along the floor. The advantages are high-speed airflow, low pressure loss, and the ability to increase airflow velocity using the floor effect. It is suitable for scenarios with compact space and a pursuit of high-speed heat dissipation. Scheme 2: Side-wing airflow duct, characterized by air passing through the side air inlet of the vehicle body and being blown directly to the radiator along the streamlined air duct. The advantages are aesthetics, reduced intrusion into the vehicle's shape, and efficient cooling of local heat sources. It is suitable for local heat dissipation optimization. Scheme 3: Dual-branch/guide vane type air duct, characterized by the main air duct being divided into two or more branches and the addition of micro guide vanes to guide air to evenly cover the cooling plate. The advantages are heat dissipation. Uniform and precisely controllable local flow rate, suitable for large battery modules or scenarios with uneven heat load distribution; Solution 4: Intake+Exhaust Integrated Airflow Duct, characterized by air being drawn in from the front grille or bumper, passing through the radiator along a streamlined channel, and then being exhausted from the rear or side wings. Advantages include smooth airflow, low overall resistance, and the ability to utilize the vehicle's natural airflow to reduce fan energy consumption, suitable for high-speed driving or long-range electric vehicles; Solution 5: Chassis/Hood Airflow Combination Airflow Duct, characterized by air entering from multiple points under the front of the vehicle, the side wings, and the gaps in the battery cover, converging to the radiator through multiple streamlined channels. Advantages include significant forced cooling effect and flexible space utilization, suitable for large battery modules or high-performance electric vehicles. It should be noted that while the air duct is an important component of the cooling system in this invention, and its design can affect airflow and heat dissipation efficiency, the core innovation of this invention does not lie in the specific streamline or shape of the air duct, but rather in the low-temperature lifespan extension and energy efficiency optimization of the battery achieved through experimental discovery and system design, effectively controlling system energy consumption, thereby achieving a balance between economy and safety throughout the entire lifespan of electric vehicles or electric transportation equipment. The scope of protection of this invention is not limited by the specific form or layout of the air duct, nor can the core technical solution of this invention be circumvented by different implementations of the air duct design. In reality, the battery capacity of most electric vehicles decreases in low-temperature environments, limiting their range. Existing electric vehicle thermal management systems mainly focus on preventing overheating or maintaining normal temperature, without specifically designed for low-temperature lifespan extension. Public information shows that the air duct design of existing mass-produced models is mostly focused on external styling, and their internal structure does not form an effective airflow guiding channel to assist in heat dissipation of the battery or key components. For example, tests and disassembly results of a Xiaomi SU7 Ultra showed that its air duct cover's internal structure was similar to a regular aluminum hood, lacking a clear airflow channel and connection to the heat dissipation components. A tissue was not noticeably moved during a blower test. This indicates that current models do not yet feature dedicated air duct designs for low-temperature lifespan extension or efficient heat dissipation.

In some embodiments, the electric fan includes a variable speed control or stepless wind speed control fan, and can further include variable pitch blades or a bidirectional impeller structure, so as to automatically adjust the air volume and blade angle according to the demand, thereby improving energy efficiency and heat dissipation efficiency.

In some embodiments, the electric fan includes a low-resistance operating structure, the low-resistance operating structure is used to allow the fan to rotate freely with the airflow direction in a high-speed airflow scenario, so as to reduce air resistance and enhance the convective ventilation effect of the radiator.

In some embodiments, the low-resistance operating structure includes at least one of the following: a non-reverse drag control circuit, a one-way clutch mechanism, a low-resistance bearing structure, a magnetic levitation bearing structure, or an automatic stop/retract blade structure.

In some embodiments, the non-reverse drag control circuit is used to suppress the reverse electric resistance generated by the motor when the fan blades are driven to rotate by high-speed airflow; the one-way clutch mechanism is used to achieve free rotation under the action of high-speed airflow, while being driven by the motor in low-wind-speed scenarios; the low-resistance bearing structure is used to reduce the rotational friction of the fan in the follow-up state; the magnetic levitation bearing is used to further reduce mechanical friction loss; the automatic stop or blade retraction structure is used to separate the fan from the airflow when the high-speed airflow is sufficient to meet the heat dissipation requirements, thereby further reducing air resistance and improving the overall heat dissipation efficiency.

In some embodiments, any functional unit or its sub-components or secondary components can be equipped with a temperature equalization device to improve the overall temperature uniformity and thermal response efficiency of the functional unit.

In some embodiments, any functional unit or its sub-components or secondary components can be covered with phase change material to freeze and store cold energy when the battery module load is low or the ambient temperature is low at night, and melt and release cold energy when the temperature rises during the day or the battery module load suddenly increases, thereby reducing the start-up frequency of the refrigeration system and achieving cross-day and cross-seasonal temperature control optimization; the phase change material can be precisely controlled by alloy formula optimization or microcapsule encapsulation technology to meet the precise temperature control requirements under different application scenarios.

In some embodiments, the phase change material can be used in a graded array or deployed in different locations in a graded manner to achieve a graded phase change process through a combination of multiple melting points, and store and release cold energy at different temperature points or different locations, thereby enhancing the ability to maintain and regulate low-temperature.

In some embodiments, the cooling and life-extending device is also equipped with a heat preservation system; When the ambient temperature is too low, the heat preservation system can quickly reduce the heat exchange efficiency of any functional unit or its sub-components or secondary components to prevent the battery module temperature from being too low; If necessary, the heat preservation system can activate an electric heating unit, a small reversible heat pump or other compensating heating device to perform compensating heating, thereby ensuring that the battery module temperature is stable in the life-extending low-temperature range rather than in an overcooled state.

In some embodiments, the cooling system further includes a bypass circuit. When the heat load of the battery module is small, the coolant can bypass the radiator and return directly to the cooling plate through the bypass circuit, thereby keeping the coolant temperature from being too low and preventing the battery module from being in an overcooled state.

In some embodiments, the anti-condensation module can also monitor the surface temperature of the battery module, the temperature of the coolant and the ambient humidity in real time, and judge the risk of condensation according to the condensation model or threshold, thereby controlling the heating device to heat the surface of the battery module or the surrounding air, or reducing the air humidity or increasing the air circulation through the air conditioning device, thereby inhibiting water vapor condensation, ensuring the safe operation of the system in a low-temperature and high humidity environment, and without affecting the low-temperature life-extending effect.

In some embodiments, the cooling and life-extending device further includes a thermosiphon circuit or a heat pipe array, which connects the battery cold plate and the radiator, and achieves partial or complete pump-free natural circulation cooling under the temperature difference drive, so that the coolant can complete the circulation without relying on the water pump, thereby still having basic low-temperature maintenance capability when the pump fails.

In some embodiments, the device is equipped with redundant control logic: when the cooling and life-extending device cannot effectively reduce the battery temperature to the low-temperature operating range (e.g., radiator failure, coolant pump failure, insufficient fan speed or excessively high ambient temperature), the redundant control logic will automatically switch to the overheat protection mode to prioritize ensuring that the battery module does not overheat, thereby improving system reliability and preventing thermal runaway.

In some embodiments, any functional unit or its sub-components or secondary components can be linked with the vehicle's powertrain, BMS, or onboard air conditioning system to switch heat dissipation strategies according to operating conditions, thereby achieving optimized temperature control for the entire vehicle.

In some embodiments, the condenser shares part of the refrigeration system with the vehicle's original air conditioning system to reduce system redundancy, lower costs and improve refrigerant circulation efficiency; However, the cooling and life-extending device can also be equipped with an evaporator and control valve independently, so that it can operate independently when the battery module needs low-temperature control, thus not affecting the comfort of the passenger compartment.

In some embodiments, the cooling and life-extending device can also integrate heat recovery function to use the heat generated by the battery module for vehicle cabin or auxiliary heating.

In some embodiments, the cooling and life-extending device can also be equipped with a damping or noise reduction device to reduce noise.

In some embodiments, the radiator adopts a variable fin spacing structure; Under normal circumstances, the fin spacing is small to improve heat exchange efficiency; In dusty or polluted environments, the fin spacing can be increased to reduce the risk of blockage, thereby maintaining a long-term stable low-temperature heat dissipation effect.

In some embodiments, any functional unit or its sub-components or secondary components can also be equipped with a spray cooling device, which can further enhance heat dissipation efficiency through spray evaporation and heat absorption in ultra-high temperature or continuous high load scenarios.

In some embodiments, the cooling and life-extending device can also be equipped with an elevated heat dissipation tower, and any functional unit or its sub-components or secondary components can be preferentially installed in the elevated heat dissipation tower.

In some embodiments, the elevated heat dissipation tower can be equipped with a shield, air guide plate, dust filter chamber and sealing protection structure, and can form an air film or air curtain through a fan, nozzle or air guide plate to reduce the direct entry of ground dust and reduce the impact of windward dust on the heat dissipation tower.

In some embodiments, the elevated heat dissipation tower can also ensure smooth airflow by rationally arranging the airflow guide structure and optimize the airflow guide in combination with the vehicle movement direction, thereby maintaining the long-term stable and efficient heat dissipation performance of the cooling and life-extending device.

In some embodiments, the elevated heat dissipation tower can be equipped with multiple axial flow fans, which can be controlled by frequency conversion or constant speed, and have a back-blowing dust removal function. The dust on the surface of the fins and pipes is removed by periodic or real-time reverse airflow. At the same time, it can be used with airflow guide plates to optimize the airflow path and reduce the risk of dust accumulation in dead corners.

In some embodiments, the elevated heat dissipation tower can be supplemented with sound waves or ultrasonic vibrations to actively shake off the attached dust, and in special cases, it can be combined with slight spray atomization pretreatment to make some dust settle in the pretreatment area to ensure long-term stable heat dissipation performance.

In some embodiments, the elevated heat dissipation tower can flexibly adjust the fan frequency and airflow direction according to the concentration of mineral dust, operating environment and seasonal changes, so as to achieve environmentally adaptive dust control.

In some embodiments, the fin spacing of the radiator can be appropriately increased, and the structural design can include trapezoidal, corrugated or spiral, and anti-stick powder or hydrophobic coating can also be applied to reduce dust adhesion and clogging.

In some embodiments, a dust removal device can be installed at the air inlet or air channel of the cooling and life-extending device, including but not limited to a filter screen, a washable filter element, a composite filter element, a microporous filter layer, a cyclone separator or an electrostatic dust collection device, to classify and intercept dust according to its size or electrical properties.

In some embodiments, the cooling and life-extending device can be equipped with a dust sensor to monitor the dust concentration in the air in real time, and automatically trigger back-blowing, vibration cleaning or spray washing functions according to the actual situation.

In some embodiments, the cooling and life-extending device can also achieve intelligent dust management by adjusting the fan adjustment strategy, optimizing the airflow structure, selecting the fin spacing, combining materials, and working together with various dust prevention measures to ensure heat dissipation efficiency and extend the device's lifespan.

In some embodiments, the cooling and life-extending device can also flexibly adjust its operating strategy according to the concentration of mine dust, operating environment and seasonal changes, and record cleaning logs to optimize the maintenance cycle and reduce maintenance costs.

In some embodiments, the internal and external operating parameters that can be monitored by the integrated control module include, but are not limited to, the temperature and temperature difference, flow rate and flow rate difference, pressure and pressure difference, liquid level, air velocity, wind pressure, airflow direction and wind speed difference of any functional unit, its sub-component or secondary component at any measuring point or location, and any difference between these measuring points or locations, such as the difference between different measuring points within the same functional unit, sub-component or secondary component, or the difference between different measuring points in different functional units, sub-components or secondary components, as well as the derived quantities calculated from the above parameters; and also include, but are not limited to, the operating status of the battery module (such as battery heat generation, single cell and module temperature, state of charge SOC/DOI, charging and discharging power, cycle number, health status), vehicle operating status (such as vehicle speed, acceleration, braking status, steering status, load, driving mode) and environmental conditions (such as ambient temperature, humidity, air pressure, wind direction and wind speed, solar radiation intensity).

In some embodiments, the controllable components include, but are not limited to, adjustable speed electric pumps, adaptive pumps, micro circulation pumps, bidirectional pumps, electronic control valves, three-way valves, four-way valves, eight-way valves, multi-way valves, flow dividers, switching valves, multi-way switching valves, throttling devices, solenoid valves, adjustable throttling valves, differential pressure regulating valves, compressors (variable frequency compressors, twin-rotor compressors, or scroll compressors), turbo expanders, adjustable condenser brackets, heat exchanger bypass valves, cooling plate adjustment components, heat pipe control switches, phase change material start/stop control devices, intelligent control modules, power drive units, non-reverse drag control circuits, and automatic stop or folding blade mechanisms.

In some embodiments, the decision control algorithm includes, but is not limited to, predetermined strategies, adaptive methods, predictive methods, fuzzy control, PID control, model predictive control (MPC), reinforcement learning, neural networks, generative large models and other data-driven or physical model-based optimization control methods, or a combination of these algorithms.

In some embodiments, the upper limit of the life-extending low-temperature range can be directly selected from the temperature values listed below (including but not limited to), or arbitrarily selected within a ±2.5° C. range of the following temperatures: −30° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.; The lower limit of the life-extending low-temperature range can be directly selected from the temperature values listed below (including but not limited to), or arbitrarily selected within a ±2.5° C. range of the following temperatures: −27.5° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.

In some embodiments, the specific melting point values of the phase change material include, but are not limited to, 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., and −25° C., and can be finely adjusted within a ±2.5° C. range of the listed values.

In some embodiments, the form of the temperature equalization device includes, but is not limited to, microchannel liquid cooling plate, liquid cooling temperature equalization plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange and aerogel insulation-thermal conductive composite structure.

Some extended embodiments are introduced below. 1) Predictive thermal management control based on artificial intelligence: The core of this embodiment lies in the predictive control algorithm. The system uses reinforcement learning or generative large models to analyze massive historical data and predict future battery thermal load. For example, when the navigation system shows that the vehicle is about to enter a long uphill section, the AI model will predict in advance that the battery will generate a lot of heat and lower the battery temperature to the lower limit of the life-extending low-temperature range before the start of the slope, reserving temperature rise space for the upcoming thermal load. This proactive strategy avoids temperature fluctuations caused by delayed response, achieves smoother and more efficient temperature control, and reduces unnecessary energy consumption. 2) Ultra-precise temperature control system based on thermoelectric cooling: This embodiment introduces a thermoelectric cooling (TEC) module on the basis of the original cooling system. This module is directly integrated into the cooling plate and generates a temperature difference through DC power to fine-tune and precisely control the temperature of the battery. The cooling system first lowers the battery temperature to a lower range, and then the TEC module precisely fine-tunes it to stabilize the temperature within a life-extending low-temperature range, for example, 10° C.±0.5° C. The TEC module can also be heated by reverse power, thus achieving true bidirectional precise temperature control. This design is particularly suitable for temperature-sensitive next-generation batteries, ensuring their long lifespan and high safety. 3) Micro reversible heat pump and coolant heating integration: This embodiment deeply integrates heat pump technology into the cooling system to achieve bidirectional temperature control. Traditional electric heaters are inefficient, while this system uses a small reversible heat pump that can absorb heat from the battery in cooling mode and absorb heat from the environment in heating mode and “pump” it into the coolant for efficient battery heating. This design significantly reduces energy consumption in winter, especially for electric vehicles that need to operate in cold regions, where its economic and range advantages will be more prominent. 4) Dynamic phase change material cold energy storage and release system: This embodiment proposes a dynamically controllable phase change material (PCM) system. Traditional PCM systems operate passively, while this system, through microencapsulation and electric, magnetic, or ultrasonic field control technology, can actively regulate its phase change temperature and rate. This allows cold energy storage and release to no longer rely solely on temperature differences, enabling intelligent scheduling based on real-time load and peak/valley electricity prices. For example, cold energy can be stored using cheap electricity during off-peak hours at night and actively released during high-load days, significantly reducing operating energy consumption and costs. 5) Reconfigurable Heat Recovery and Multi-Source Heat Utilization System: This embodiment proposes a reconfigurable heat recovery system. Through multi-port valves and bypass circuits, the heat generated by the battery can be directed to different heat utilization units as needed, such as for heating the passenger compartment, preheating the battery during low-temperature charging, or heating vehicle auxiliary systems. The system can also recover waste heat from the motor controller or the motor itself, achieving cross-system heat recovery and utilization, greatly improving energy efficiency. 6) Hybrid Cooling of Integrated Heat Pipe Array and Liquid Cooling Plate: This embodiment deeply integrates efficient heat pipe technology with traditional liquid cooling plates to form a heat pipe-liquid cooling hybrid plate. Embedded heat pipes can rapidly transfer heat from local hot spots to the coolant channels with ultra-high equivalent thermal conductivity, thereby achieving rapid heat homogenization and significantly improving the temperature uniformity inside the battery module. This design combines the advantages of efficient heat pipe homogenization and large-capacity heat dissipation of liquid cooling, providing dual protection and better temperature field management for the system. 7) Intelligent airflow guiding structure based on fluid dynamics: This embodiment uses computational fluid dynamics (CFD) simulation to design an intelligent variable airflow guiding structure. This structure integrates multiple variable geometry guide plates and vortex generators, which can be adjusted according to real-time data to optimize the airflow distribution on the radiator. This design ensures uniform and efficient airflow on the heat exchange surface, eliminates local hot spots, maximizes heat dissipation efficiency, and reduces wind resistance and noise. 8) Temperature homogenization structure based on high thermal conductivity graphene: This embodiment introduces a high thermal conductivity graphene composite material between the cooling plate and the battery module. Graphene has ultra-high in-plane thermal conductivity. Encapsulating its film or aerogel between the battery cell and the cooling plate can form a “thermal conduction layer”. This layer can uniformly diffuse heat in a two-dimensional plane at an ultra-fast speed, eliminating local hot spots before the heat reaches the cooling plate, significantly improving temperature uniformity. It is particularly suitable for fast charging or high-rate discharging scenarios where thermal uniformity is extremely important. 9) Pump-free thermosiphon-based backup cooling system: This embodiment utilizes the thermosiphon principle to realize a pump-free natural circulation cooling system. When the battery generates heat during operation, the coolant evaporates at the cooling plate, rises into the radiator, condenses into liquid, and flows back under gravity. This system serves as a backup or low-load cooling method without consuming electricity to drive a coolant pump, making it particularly suitable for scenarios requiring long-term shutdown or low-power monitoring. 10) Multi-material composite cooling plate and optimized heat conduction path: This embodiment proposes a multi-material composite cooling plate design, combining materials with different thermal conductivity to optimize heat transfer. For example, the part in contact with the battery uses a high thermal conductivity copper or graphene composite material, while the pipeline flow channel uses a lightweight aluminum alloy. This “material selection on demand” design achieves an optimal balance between weight, cost, and heat dissipation performance, making it a multifunctional, composite heat-conducting structure. 11) Layered Dust Removal and Self-Cleaning Heat Dissipation Tower: This embodiment addresses the specific needs of electric transportation equipment in dusty environments by proposing a multi-stage, self-cleaning layered heat dissipation tower. The tower integrates a cyclone separator, a self-cleaning microporous filter, and radiator fins with a backflushing function. This “layered protection, active cleaning” design reduces dust entry at the source and continuously removes internal dust, ensuring the radiator maintains high efficiency even in extremely harsh environments. 12) Variable Fin Spacing and Coated Radiator: This embodiment proposes a variable fin spacing (VCS) radiator. This radiator can dynamically adjust the fin spacing based on dust sensors or operating conditions. In clean environments, the fin spacing can be reduced to maximize heat exchange efficiency; in high-dust areas, it automatically increases to prevent clogging. Furthermore, combined with a self-cleaning coating or ultrasonic vibration module, this design perfectly balances heat exchange efficiency and anti-clogging capability, solving the pain point of traditional radiators' performance degradation in extreme environments. 13) Dynamic adjustment of the life-extending low-temperature range based on multi-factor optimization: This embodiment extends the life-extending low-temperature range from a fixed range to a dynamically adjustable range. The system utilizes neural networks or reinforcement learning algorithms to comprehensively consider multiple factors such as battery health status, ambient temperature, state of charge, and driving mode, and calculates and predicts the “optimal” temperature range in real time. For example, when high power output is required, the system can raise the life-extending low-temperature range to 15° C. to ensure performance; and lower it to 5° C. under low load to maximize lifespan. 14) Intelligent scheduling system based on IoT and cloud: This embodiment connects the thermal management system with the Internet of Things (IoT) and cloud platform to achieve intelligent remote scheduling and predictive maintenance. The vehicle's thermal management data is uploaded to the cloud in real time and fused with meteorological data, map data, and historical operating data for analysis. The cloud platform can predict future heat loads or component failure risks in advance and send control commands to the vehicle or warning information to management personnel, thereby achieving a “prevention-oriented” maintenance strategy. 15) Integrated packaging of battery module and thermal management system: This embodiment integrates the battery module, cooling plate, and thermal management pipelines into a deep package. This solution embeds the cooling pipes directly into the packaging structure of the battery cell or module, greatly shortening the heat conduction path. The entire system is packaged to a high standard, forming a completely sealed “self-contained” thermal management module. This design improves the system's integration and compactness, reduces leakage risks, simplifies the vehicle assembly process, and provides great design flexibility.

It should be understood that the embodiments disclosed in this specification are merely illustrative examples, and their designs, structures, and combinations are used to explain the principles and effects of the invention, not to limit the invention. Those skilled in the art, after reading this, can make equivalent substitutions, modifications, improvements, or combinations to the embodiments without departing from the spirit and substance of the invention, and all such substitutions should be included within the scope of protection. The embodiments are described in a progressive and complementary manner, with each embodiment highlighting its main differences, and similar or identical parts referring to other embodiments. The technical features described can be arbitrarily combined, cross-referenced, or used in combination without creating contradictions, and such combinations should also be considered to fall within the scope of protection. The technical solutions of this invention are not only applicable to the illustrated embodiments but can also be extended to other related fields or systems. Those skilled in the art can make improvements or optimizations according to actual needs, including structural adjustments, component replacements, functional expansions, or parameter modifications, and all of these should be considered part of the scope of protection. The scope of protection of this invention is not limited to specific embodiments but covers all technical features, feature combinations, and their equivalent solutions. All modifications, extensions, improvements, or substitutions made within the scope of the principles and spirit of this invention, whether implemented alone or in combination, are within the scope of protection. In summary, the technical solution proposed in this invention can achieve the expected results and is applicable to different application scenarios. Its protection scope is determined by the claims. Any modifications, equivalent substitutions, or application extensions within the scope of the claims shall be protected by law.

This invention has significant practical value in industrial applications. First, by controlling the battery module in the long-term life-extending low-temperature rangespan, the aging of electrode materials and electrolyte can be significantly delayed, extending the battery cycle life and overall life-cycle economy, providing an efficient and reliable energy storage solution for electric vehicles and electric transportation equipment. Second, the cooling and life-extending device of this invention has overwhelming advantages in system design: the combination of multi-stage cooling, optimized air ducts, thermal connection/insulation strategies, and capacity redundancy design achieves efficient, balanced, and dynamic control under the low-temperature life-extending target, while also taking energy saving into account, which is significantly better than existing single liquid cooling or air cooling technologies. Third, this invention has high adaptability and reliability: the modular and integrated design facilitates maintenance and upgrades, the redundancy design ensures that the system can still operate stably when some units fail, and the high-dust environment protection strategy ensures long-term efficient heat dissipation for mining vehicles. Fourth, this invention achieves closed-loop optimized control under the battery life-extending target through the intelligent temperature control module combined with multiple sensors, decision algorithms, and external parameter linkage, and ensures battery performance and safety in low-temperature environments through capacity redundancy and anti-condensation strategies. In summary, this invention provides an innovative battery life-extending technology that not only achieves a significant lifespan extension but also achieves energy efficiency through system optimization and intelligent control, forming an overall advantage that cannot be matched by existing technologies. It provides a completely new and unexpected solution for electric vehicle battery systems and has significant industrial application prospects and economic value.

1. A cooling and life-extending device applicable to electric transportation equipment and its auxiliary facilities, characterized in that:
The cooling and life-extending device includes several functional units, sub-components and secondary components; The functional units can include, but are not limited to: battery module, cooling system, and air duct;
The sub-components of the cooling system include a coolant pump, a radiator, a cooling plate, and interconnected cooling pipes;
The air duct defines the airflow path, allowing air to flow through the radiator, and the air is finally discharged to the outside after heat exchange;
The battery module undertakes the core functions of energy storage and output, and is the core component of the electric transportation equipment and its auxiliary facilities; It is also the direct cooling target and life-extending carrier of the cooling and life-extending device;
The cooling and life-extending device can stably control the temperature of the battery module within the life-extending low-temperature range, thereby extending the life of the battery module and significantly enhancing its economic efficiency throughout its entire life cycle;
The life-extending low-temperature range is a low-temperature range below room temperature but above the dew point; When the battery module is used for a long time within this life-extending low-temperature range, it can slow down the aging and degradation of electrode materials and electrolyte, thereby extending its lifespan;
The cooling system contains circulating coolant; A coolant pump drives the coolant to circulate within the cooling system; The cooling plate is in close contact with the battery module that needs cooling, enabling the coolant to efficiently absorb the heat generated by the battery module during operation; The coolant is transported to a radiator via cooling pipes, where the radiator exchanges heat with the air through convection; The cooled coolant then flows back to the cooling plate, achieving a continuous and stable cooling effect; The cooling plate can also be in close contact with other sub-components or secondary components that need cooling to achieve the purpose of cooling;
The functional unit refers to the overall module in the cooling and life-extending device used to realize the main function; The sub-component refers to the subdivided structure or independently operable component under the functional unit; The secondary component refers to the specific element or hardware component after the sub-component is further subdivided.

2. The cooling and life-extending device according to claim 1, characterized in that,
The cooling and life-extending device is used to actively promote the temperature reduction of the battery module and maintain it in the life-extending low-temperature range, rather than just to prevent thermal runaway; The functional unit of the cooling and life-extending device can be replaced with other structures, or combined with other structures to achieve the above-mentioned purpose of cooling and life-extending; The functional unit can also select to implement any of the following temperature control strategies according to specific needs: passive heat dissipation, air cooling, convection cooling, active cooling or thermal compensation, or select a combination of multiple strategies to construct a multi-stage coupled temperature control system;
The air duct can also cause air to flow through any functional unit or its sub-components or secondary components and exchange heat with them, thereby enhancing the overall heat dissipation effect of the cooling and life-extending device;
Each functional unit, sub-component and secondary component in the cooling and life-extending device is optional, wherein the electrically related parts have a sealed structure to suppress condensation and improve adaptability under low-temperature conditions;
When the battery module operates in the life-extending low-temperature range, although its lifespan can be extended, its electrochemical reaction rate is reduced, resulting in a reduction in initial capacity; therefore, the battery module is configured with a capacity redundancy function;
The capacity redundancy function is achieved by pre-setting additional redundant capacity for the battery module to compensate for the capacity loss of the battery module when operating in a low-temperature environment; the capacity redundancy function is an optional configuration;
The functional unit of the cooling and life-extending device further includes: an integrated control module;
The integrated control module can also monitor the internal and external operating parameters of the electric transportation equipment, its auxiliary facilities and the cooling and life-extending device in real time, then analyze the parameters through a decision control algorithm, and adjust the operating strategy and/or operating intensity of the cooling and life-extending device as needed based on the analysis results, so as to enhance the continuous temperature control capability and the precise temperature control capability;
The integrated control module can ensure that one or more operating characteristics of the battery module do not exceed the preset operating condition threshold during charging and discharging, so as to avoid the rapid increase of the side reaction rate of the battery module under adverse operating conditions;
The range of the life-extending low-temperature range and the setting of the preset operating condition threshold can vary depending on the type and model of the battery module, and can be affected by the chemical system, capacity, rated voltage and operating environment conditions of the battery module.

3. The cooling and life-extending device according to claim 2, characterized in that,
The functional unit of the cooling and life-extending device further includes: a refrigeration system;
The capacity redundancy function can be achieved by adding a battery expansion pack and cooperating with the battery module to achieve excess redundancy; or by designing the total capacity of the battery module according to a preset redundancy ratio to achieve excess redundancy design from the source of the solution;
The capacity redundancy function can not only compensate for the capacity loss of the battery module in the low-temperature life-extending range, but also further improve the life of the battery module on the basis of the life-extending caused by low-temperature;
The refrigeration system is activated when the ambient temperature is too high or the heat dissipation efficiency of the cooling system is insufficient to reduce the coolant to the target temperature, so as to further enhance the heat dissipation effect of the cooling and life-extending device and ensure that the battery module is in the life-extending low-temperature range;
The operating characteristics include one or more of the following: charging current, charging voltage, discharging voltage, discharging current, charging and discharging power, temperature, and other battery operating condition parameters;
An electric fan can be additionally installed in the air duct; The electric fan can actively promote airflow when there is a lack of natural wind or relative airflow, so as to maintain the heat dissipation capacity of the air duct;
The cooling and life-extending device can be configured with a multi-stage cooling strategy: primary cooling is achieved by the cooling system and air duct in conjunction with natural wind or relative airflow, without the need for additional energy consumption; secondary cooling is assisted by an electric fan; tertiary cooling is initiated by the refrigeration system to achieve cooling and temperature control under extreme high-temperature conditions; the multi-stage cooling strategy can be arbitrarily combined and switched by the control module to ensure that the cooling and life-extending device can adjust the temperature of the battery module as needed under any operating condition;
The life-extending low-temperature range can be around 10° C., around 15° C., around 20° C., or other temperature ranges below room temperature.

4. The cooling and life-extending device according to claim 3, characterized in that,
When the integrated control module detects that one or more operating characteristics are close to or exceed the preset operating condition threshold, a protection mechanism will be triggered; The protection mechanism includes, but is not limited to: reducing the charging current, reducing the discharging current, reducing the charging and discharging power and/or voltage, performing a circuit breaker action, and issuing an alarm signal;
The sub-components of the refrigeration system include a condenser, a compressor, a throttling device, an evaporator, and interconnected refrigeration pipes;
The refrigeration system contains a refrigerant; the refrigerant circulates and undergoes a phase change within the refrigeration system, and exchanges heat with each sub-component of the refrigeration system in sequence;
The life-extending low-temperature range and/or preset operating condition threshold can be determined through experiments, tests or a combination of those methods;
Specific determination methods include but are not limited to: determining by accelerated aging test, charge-discharge cycle test or thermal characteristic analysis; selecting based on experience or manufacturer recommendations; predicting by combining battery thermal management model, aging model or chemical kinetic simulation; performing statistical analysis based on historical operating data; and determining by multi-factor combination optimization method;
The specific control measures that the integrated control module can take include, but are not limited to, dynamically adjusting the execution sequence, operating mode, operating parameters, and operating intensity of any functional unit or its sub-components or secondary components, or reconstructing or switching the topological connection structure of any functional unit or its sub-components, secondary components, and secondary components; enabling the battery module to achieve temperature balance and maintain it in the life-extending low-temperature range under different operating conditions, thereby stabilizing the life-extending effect; and also configuring a series of controllable components in the cooling and life-extending device to achieve flexible adjustment as needed;
Any functional unit or its sub-components or secondary components can be quickly connected through multi-way valves, quick-connect pipes, bypass circuits, or quick-switching interfaces; This allows the integrated control module to dynamically adjust the execution sequence, operating mode, operating parameters, and operating intensity of any functional unit or its sub-components, secondary components, and secondary components, or to reconstruct or switch the topological connection structure of any functional unit or its sub-components, secondary components, and secondary components.

5. The cooling and life-extending device according to claim 4, characterized in that,
Any functional unit or its sub-components or secondary components can be arranged in a coordinated manner for different parts of the battery module and work in coordination according to the zones to achieve differentiated heat dissipation and local temperature control, thereby improving the overall thermal management performance;
The functional unit of the cooling and life-extending device further includes an anti-condensation module; the anti-condensation module can be automatically activated when the battery module temperature is close to the dew point to reduce the humidity of the air around the battery module, so that the dew point is lower than the battery surface temperature, thereby preventing condensation on the battery surface and ensuring the safe operation of the battery;
Any functional unit or its sub-components or secondary components can be designed in a branched manner to disperse heat dissipation for different parts of the battery module and improve temperature uniformity;
Any functional unit or its sub-components or secondary components can be repeatedly configured as needed to achieve fault redundancy, so that when some units fail, other units can take over the operation to ensure system stability; at the same time, heat dissipation can be enhanced by adding parallel radiator units to improve the overall heat dissipation capacity; and hierarchical control can be achieved by hierarchical start-stop and adjustment of multiple units, so as to take into account both energy efficiency and precise control;
Any functional unit or its sub-components or secondary components can be subjected to thermal connection interactively as needed, thereby improving the heat exchange efficiency between functional units and optimizing the overall system's heat dissipation performance; This thermal connection can achieve rapid heat exchange directly by connecting any functional unit or its sub-components or secondary components, or it can achieve indirect heat conduction by arranging heat exchange plates, heat dissipation fins, heat pipes, thermal bridges, heat conduction pipelines, or using heat exchange media (such as liquid cooling media or phase change materials) between any functional unit or its sub-components or secondary components; Alternatively, any functional unit or its sub-components or secondary components can also be equipped with thermal insulation structures as needed to block unwanted thermal connection; Various methods, including thermal insulation boards, thermal insulation jackets, air layers, low thermal conductivity materials, or insulation layers, can be used to slow down heat transfer, thereby preventing localized overheating while maintaining necessary heat exchange efficiency, and improving system safety and temperature uniformity; The two design methods (thermal connection/thermal insulation) can be selected independently without conflict;
Any functional unit or its sub-components or secondary components can adopt a modular design concept as needed to form independent modules. Through flexible pipelines, quick connectors and standardized interfaces, a structure that is easy to couple and disassemble can be achieved, so that each unit can be disassembled for cleaning or replacement, thereby reducing maintenance costs and downtime, improving the maintainability and adaptability of the system, and facilitating flexible configuration and upgrading; or, any functional unit or its sub-components or secondary components can also adopt an integrated design as needed, coupling any functional unit or its sub-components or secondary components into an overall structure, improving the heat exchange efficiency between them, reducing heat loss, improving thermal management efficiency, shortening pipelines, and improving structural compactness; these two design methods (modular design/integrated design) can be selected independently and do not conflict with each other.

6. The cooling and life-extending device according to claim 5, characterized in that,
The compressor compresses the low-pressure gaseous refrigerant into a high-temperature and high-pressure gas, which is then sent to the condenser through the refrigeration pipe to release heat and condense it into a liquid; subsequently, the refrigerant enters the evaporator after being depressurized and cooled by the throttling device, where it absorbs heat and evaporates into a gas, and then returns to the compressor to form a cyclic refrigeration process; wherein, the condenser is coupled with the air duct, and the heat released by the refrigerant in the condenser is transferred through the air duct and finally discharged to the outside; the evaporator is coupled with the radiator (or other components) in the cooling system, and the refrigerant absorbs heat in the evaporator, thereby reducing the temperature of the radiator in the cooling system and achieving auxiliary cooling of the coolant;
The air duct can be configured as a multi-stage diversion structure or a parallel channel structure to realize the flow distribution and convergence of air and path selection, so that the air flows sequentially or separately through any of the functional units or their sub-components and secondary components and exchanges heat with them, thereby optimizing air distribution, improving heat dissipation uniformity and reducing wind resistance;
The air duct can adopt an automatic switching structure or an adjustable opening structure, which can dynamically adjust the air flow path or opening size according to the needs to optimize wind resistance and heat dissipation efficiency;
The air duct can be equipped with a guide plate (adjustable), an adjustable baffle (servo driven), a vortex generator, a damper (variable opening), louvers or adjustable blades to improve the airflow path, reduce dead zones or local hot spots, and adjust the airflow direction and flow rate as needed;
The electric fan includes a variable speed control or stepless wind speed control fan, and can further include variable pitch blades or a bidirectional impeller structure, so as to automatically adjust the air volume and blade angle according to the demand, thereby improving energy efficiency and heat dissipation efficiency;
The electric fan includes a low-resistance operating structure, the low-resistance operating structure is used to allow the fan to rotate freely with the airflow direction in a high-speed airflow scenario, so as to reduce air resistance and enhance the convective ventilation effect of the radiator;
The low-resistance operating structure includes at least one of the following: a non-reverse drag control circuit, a one-way clutch mechanism, a low-resistance bearing structure, a magnetic levitation bearing structure, or an automatic stop/retract blade structure;
The non-reverse drag control circuit is used to suppress the reverse electric resistance generated by the motor when the fan blades are driven to rotate by high-speed airflow; the one-way clutch mechanism is used to achieve free rotation under the action of high-speed airflow, while being driven by the motor in low-wind-speed scenarios; the low-resistance bearing structure is used to reduce the rotational friction of the fan in the follow-up state; the magnetic levitation bearing is used to further reduce mechanical friction loss; the automatic stop or blade retraction structure is used to separate the fan from the airflow when the high-speed airflow is sufficient to meet the heat dissipation requirements, thereby further reducing air resistance and improving the overall heat dissipation efficiency.

7. The cooling and life-extending device according to claim 6, characterized in that,
The throttling device is preferably a thermostatic expansion valve or an electronic expansion valve, or it can be a capillary tube, a float valve, a needle valve, an electronic proportional valve, a two-stage expansion valve or an adjustable orifice capillary tube, etc., which can adjust the refrigerant flow according to the load of the evaporator or the system control requirements, thereby ensuring the stable heat absorption and circulating cooling effect of the evaporator;
Any functional unit or its sub-components or secondary components can be equipped with a temperature equalization device to improve the overall temperature uniformity and thermal response efficiency of the functional unit;
Any functional unit or its sub-components or secondary components can be covered with phase change material to freeze and store cold energy when the battery module load is low or the ambient temperature is low at night, and melt and release cold energy when the temperature rises during the day or the battery module load suddenly increases, thereby reducing the start-up frequency of the refrigeration system and achieving cross-day and cross-seasonal temperature control optimization; the phase change material can be precisely controlled by alloy formula optimization or microcapsule encapsulation technology to meet the precise temperature control requirements under different application scenarios;
The phase change material can be used in a graded array or deployed in different locations in a graded manner to achieve a graded phase change process through a combination of multiple melting points, and store and release cold energy at different temperature points or different locations, thereby enhancing the ability to maintain and regulate low-temperature;
The cooling and life-extending device is also equipped with a heat preservation system;
When the ambient temperature is too low, the heat preservation system can quickly reduce the heat exchange efficiency of any functional unit or its sub-components or secondary components to prevent the battery module temperature from being too low; If necessary, the heat preservation system can activate an electric heating unit, a small reversible heat pump or other compensating heating device to perform compensating heating, thereby ensuring that the battery module temperature is stable in the life-extending low-temperature range rather than in an overcooled state;
The cooling system further includes a bypass circuit; When the heat load of the battery module is small, the coolant can bypass the radiator and return directly to the cooling plate through the bypass circuit, thereby keeping the coolant temperature from being too low and preventing the battery module from being in an overcooled state;
The anti-condensation module can also monitor the surface temperature of the battery module, the temperature of the coolant and the ambient humidity in real time, and judge the risk of condensation according to the condensation model or threshold, thereby controlling the heating device to heat the surface of the battery module or the surrounding air, or reducing the air humidity or increasing the air circulation through the air conditioning device, thereby inhibiting water vapor condensation, ensuring the safe operation of the system in a low-temperature and high humidity environment, and without affecting the low-temperature life-extending effect;
The cooling and life-extending device further includes a thermosiphon circuit or a heat pipe array, which connects the battery cold plate and the radiator, and achieves partial or complete pump-free natural circulation cooling under the temperature difference drive, so that the coolant can complete the circulation without relying on the water pump, thereby still having basic low-temperature maintenance capability when the pump fails.

8. The cooling and life-extending device according to claim 7, characterized in that,
The device is equipped with redundant control logic: when the cooling and life-extending device cannot effectively reduce the battery temperature to the low-temperature operating range (e.g., radiator failure, coolant pump failure, insufficient fan speed or excessively high ambient temperature), the redundant control logic will automatically switch to the overheat protection mode to prioritize ensuring that the battery module does not overheat, thereby improving system reliability and preventing thermal runaway;
The cooling and life-extending device can also be equipped with a damping or noise reduction device to reduce noise;
The radiator adopts a variable fin spacing structure; Under normal circumstances, the fin spacing is small to improve heat exchange efficiency; In dusty or polluted environments, the fin spacing can be increased to reduce the risk of blockage, thereby maintaining a long-term stable low-temperature heat dissipation effect;
Any functional unit or its sub-components or secondary components can be integrated with the battery module to make the heat dissipation structure closely integrated with the battery module, thereby achieving centralized heat dissipation and overall temperature control, and further improving the compactness and heat dissipation efficiency of the device;
The cooling and life-extending device is equipped with partitions to divide the battery module into multiple independent module compartments to form a modular thermal management structure, and to isolate the fault when a single module malfunctions, so as to avoid the risk from spreading to other modules;
Any functional unit or its sub-components or secondary components can also be equipped with a spray cooling device, which can further enhance heat dissipation efficiency through spray evaporation and heat absorption in ultra-high temperature or continuous high load scenarios;
The internal and external operating parameters that can be monitored by the integrated control module include, but are not limited to, the temperature and temperature difference, flow rate and flow rate difference, pressure and pressure difference, liquid level, air velocity, wind pressure, airflow direction and wind speed difference of any functional unit, its sub-component or secondary component at any measuring point or location, and any difference between these measuring points or locations, as well as the derived quantities calculated from the above parameters; and also include, but are not limited to, the operating status of the battery module (such as battery heat generation, single cell and module temperature, state of charge SOC/DOI, charging and discharging power, cycle number, health status) and environmental conditions (such as ambient temperature, humidity, air pressure, wind direction and wind speed, solar radiation intensity).

9. The cooling and life-extending device according to claim 8, characterized in that,
The cooling and life-extending device can also be equipped with an elevated heat dissipation tower, and any functional unit or its sub-components or secondary components can be preferentially installed in the elevated heat dissipation tower;
The elevated heat dissipation tower can be equipped with a shield, air guide plate, dust filter chamber and sealing protection structure, and can form an air film or air curtain through a fan, nozzle or air guide plate to reduce the direct entry of ground dust and reduce the impact of windward dust on the heat dissipation tower;
The elevated heat dissipation tower can be equipped with multiple axial flow fans, which can be controlled by frequency conversion or constant speed, and have a back-blowing dust removal function; The dust on the surface of the fins and pipes is removed by periodic or real-time reverse airflow; At the same time, it can be used with airflow guide plates to optimize the airflow path and reduce the risk of dust accumulation in dead corners;
The elevated heat dissipation tower can be supplemented with sound waves or ultrasonic vibrations to actively shake off the attached dust, and in special cases, it can be combined with slight spray atomization pretreatment to make some dust settle in the pretreatment area to ensure long-term stable heat dissipation performance;
The fin spacing of the radiator can be appropriately increased, and the structural design can include trapezoidal, corrugated or spiral, and anti-stick powder or hydrophobic coating can also be applied to reduce dust adhesion and clogging;
A dust removal device can be installed at the air inlet or air channel of the cooling and life-extending device, including but not limited to a filter screen, a washable filter element, a composite filter element, a microporous filter layer, a cyclone separator or an electrostatic dust collection device, to classify and intercept dust according to its size or electrical properties;
The cooling and life-extending device can be equipped with a dust sensor to monitor the dust concentration in the air in real time, and automatically trigger back-blowing, vibration cleaning or spray washing functions according to the actual situation;
The cooling and life-extending device can also achieve intelligent dust management by adjusting the fan adjustment strategy, optimizing the airflow structure, selecting the fin spacing, combining materials, and working together with various dust prevention measures to ensure heat dissipation efficiency and extend the device's lifespan;
The cooling and life-extending device can also flexibly adjust its operating strategy according to the concentration of mine dust, operating environment and seasonal changes, and record cleaning logs to optimize the maintenance cycle and reduce maintenance costs.

10. The cooling and life-extending device according to claim 9, characterized in that,
The controllable components include, but are not limited to, adjustable speed electric pumps, adaptive pumps, micro circulation pumps, bidirectional pumps, electronic control valves, three-way valves, four-way valves, eight-way valves, multi-way valves, flow dividers, switching valves, multi-way switching valves, throttling devices, solenoid valves, adjustable throttling valves, differential pressure regulating valves, compressors (variable frequency compressors, twin-rotor compressors, or scroll compressors), turbo expanders, adjustable condenser brackets, heat exchanger bypass valves, cooling plate adjustment components, heat pipe control switches, phase change material start/stop control devices, intelligent control modules, power drive units, non-reverse drag control circuits, and automatic stop or folding blade mechanisms;
The upper limit of the life-extending low-temperature range can be directly selected from the temperature values listed below (including but not limited to), or arbitrarily selected within a ±2.5° C. range of the following temperatures: −30° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.; The lower limit of the life-extending low-temperature range can be directly selected from the temperature values listed below (including but not limited to), or arbitrarily selected within a ±2.5° C. range of the following temperatures: −27.5° C., −25° C., −22.5° C., −20° C., −17.5° C., −15° C., −12.5° C., −10° C., −7.5° C., −5° C., −2.5° C., 0° C., 2.5° C., 5° C., 7.5° C., 10° C., 12.5° C., 15° C., 17.5° C., 20° C., 22.5° C., 25° C., 30° C.;
The specific melting point values of the phase change material include, but are not limited to, 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., and −25° C., and can be finely adjusted within a ±2.5° C. range of the listed values;
The form of the temperature equalization device includes, but is not limited to, microchannel liquid cooling plate, liquid cooling temperature equalization plate, serpentine tube liquid cooling, immersion liquid cooling structure, air-cooled heat dissipation duct, forced convection air cooling, hot air circulation channel, heat pipe, flat plate heat pipe, steam chamber, graphite sheet thermal conductive layer, graphene film, carbon nanotube thermal conductive film, metal foam thermal conductive structure, thermal conductive gel, thermal conductive silicone grease, thermal conductive pad, spray cooling, boiling heat exchange and aerogel insulation-thermal conductive composite structure;
The internal and external operating parameters that can be monitored by the integrated control module include, but are not limited to, the vehicle operating status (such as vehicle speed, acceleration, braking status, steering status, load, driving mode);
Any functional unit or its sub-components or secondary components can be linked with the vehicle's powertrain, BMS, or onboard air conditioning system to switch heat dissipation strategies according to operating conditions, thereby achieving optimized temperature control for the entire vehicle;
The condenser shares part of the refrigeration system with the vehicle's original air conditioning system to reduce system redundancy, lower costs and improve refrigerant circulation efficiency; However, the cooling and life-extending device can also be equipped with an evaporator and control valve independently, so that it can operate independently when the battery module needs low-temperature control, thus not affecting the comfort of the passenger compartment;
The cooling and life-extending device can also integrate heat recovery function to use the heat generated by the battery module for vehicle cabin or auxiliary heating;
The elevated heat dissipation tower can also ensure smooth airflow by rationally arranging the airflow guide structure and optimize the airflow guide in combination with the vehicle movement direction, thereby maintaining the long-term stable and efficient heat dissipation performance of the cooling and life-extending device;
The elevated heat dissipation tower can flexibly adjust the fan frequency and airflow direction according to the concentration of mineral dust, operating environment and seasonal changes, so as to achieve environmentally adaptive dust control.
